(19) United States
(12) Patent Application Publication
(10) Pub. No.: US 2003/0187978 A1
(43) Pub. Date: Oct. 2, 2003

(54) Service request agency method, service request agency server and service request agency system

(76) Inventors: Katsuichi Nakamura, Fukuoka (JP); Arnold P. Siboro, Fukuoka (JP); Yoshiharu Sato, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/269,161

(22) Filed: Oct. 11, 2002

(30) Foreign Application Priority Data
Mar. 28, 2002 (JP) 2002-092738

(51) Int. Cl. G06F 15/173

(52) U.S. Cl. 709/224; 709/203

(57) ABSTRACT

A service request agency method of surrogating a service request to a first server for providing a service corresponding to the service request, includes monitoring a state of the first server, transferring the service request to the first server after judging that the first server is not in a state of being able to properly provide a service, making a second server obtain the transferred service request, retaining the obtained service request on a storage module, and notifying the first server of the service request retained on the storage module when judging that the first server reverts to the state of being able to properly provide the service.

### BACKGROUND OF THE INVENTION

The present invention relates to a service request agency (surrogate) method, a service request agency server and a service request agency system for surrogating a service request to a first server for providing a service corresponding to the service request obtained via a network.

With an explosive spread of the Internet, a variety of services have hitherto been provided over the Internet by utilizing Web servers. The Web server falls into a high-load state due to concentrated accesses from customers or is temporarily stopped, with the result that the services are hard to be stably provided to the customers in some cases. The Web server especially on a popular service site tends to fall into such a state.

The following systems are known conventional technologies for stably providing the services to the customers.

(1) Load Sharing System Based on Load Balancer

This load sharing system schemes to provide satisfactory services to the customers by allocating the customer accesses to the Web server to a plurality of Web servers. For attaining this, a scheme is to take a load balance by configuring the plurality of Web servers.

(2) Clustering System

This clustering system has such a scheme that even if a trouble occurs in the Web server, a substitute server immediately takes over the processes and the data thereof, and the users can operate without being aware of an influence of the trouble. An architecture is therefore that a plurality of Web servers are connected to each other and made to behave as if one single computer does on the whole as viewed from the users with the result that even one Web server stops but does not appear stopped to the users.

(3) Content Cache System Based on Proxy Server

This content cache system schemes to improve a response time when the customer accesses the Web server and to reduce a load on the Web server, and involves the use of a proxy server. The proxy server runs as software (on a computer) or functions as a server machine (gateway) for intercepting accesses to various categories of services such as multimedia databases, WWW (World Wide Web) etc on the Internet. The proxy server is used for reducing a data traffic between intranets and the Internet (a caching function).

For instance, when a user in the office accesses a Web page, the proxy server caches a content thereof. when a different user accesses the same page next time, the proxy server may simply return the information cached therein to the user. Thus, both a frequency of the direct accessing to the Internet and the load on the Web server can be reduced.

(4) Queuing System Under Access control

This queuing system schemes to provide stable services to the customers by guiding excessive customer accesses (requests) to a queuing server. An architecture is therefore that the Web server for providing the services to the customers accepts only smoothly processable accesses (requests), the extra requests are guided to and queued up in the queuing server that provides a queuing service, the queued-up requests corresponding to a free processing capacity of the Web server are guided back to the Web server, thereby stabilizing the services provided by the Web server.

FIG. 36 is a view showing a system architecture of the prior art system related to the present invention. FIG. 37 shows an overview of principles of the prior art systems.

(1) The load sharing system based on the load balancer is configured by the load balancer for distributing the accesses from the customers, and a plurality of Web servers for providing pieces of information on commercial articles to the customers and purchasing the articles and so on. The load balancer includes a load sharing module for distributing the customer accesses. The Web server has a function of providing the information and accepting processes on the Internet.

Simply grasping the Web server as in the principle view, the Web server includes, for example, an information providing module for pieces information on functions and prices of the products to the customers, a process accept module for accepting a purchase request from the customer who desires to purchase the article, and a process execution module for executing the purchase process as the purchase request from the customer indicates.

(2) The clustering system is configured by a plurality of Web servers each incorporating a function of performing communications when a failover occurs. The Web server includes a failover detection module for troubleshooting, and a failover notifying module for notifying other Web servers of the trouble.

According to the load sharing system based on the load balancer (1) that performs load balancing by starting up the plurality of Web servers and the clustering system (2) in which the plurality of Web servers are made behave as one single computer, however, when scheming to smoothly provide the services to the customers, there is a necessity of starting up the plurality of Web servers enough to execute the processes at a peak of accessing from the customers. Hence, a problem is that a service site administrator who provides the services on the Internet has no alternative but to make an excessive investment in the equipment.

The content cache system based on the proxy server (3) is configured by a cache server installed on the user side and a Web server for providing the information tot he user. The Web server has a function of providing the information on the Internet. Simply grasping the Web server as in the principle view, for instance, the Web server includes an information providing module for providing the information on the functions and prices of the products to the customers.

The cache server includes a cache judging module for judging whether a cache database of the cache server contains a content that the customer is to access, and a caching module for fetching, if not stored on the cache database, this content from the Web server and registering this content on the cache database.

The content cache system based on the proxy server (3), however, has such a problem that a Web page requiring input information from the customer who purchases the product is not utilizable.

The queuing system under the access control (4) is configured by an access control server for monitoring the network and the servers and guiding the accesses (requests) processable by the Web server to this Web server and guiding extra requests to the queuing server, and the queuing server for notifying the customers that the accesses (requests) to the Web server are queued up.

The access control server includes a network server monitoring module for monitoring operating states of the network and the server and, if a trouble occurs in the network or the server, requesting a network control module to redirect the to-the-Web-server access to the queuing server, the network control module for guiding the to-the-Web-server access to the queuing server and permitting, if the Web server comes to have a free processing capacity, accessing to the Web server, and an access queue control module for controlling a queue of the customer's accesses to the Web server. The queuing server includes an information providing module for notifying the customers that the accesses to the Web server are now queued up.

The queuing system under the access control (4) has, however, a problem in which the queuing server keeps the customer (access) waiting. Another problem might arise, wherein if the waiting time is too long, the customers give up receiving the queuing service and might fleet away to other service sites.

It is a primary object of the present invention to provide a stable service to the customer even if the server gets out of a state of being able to properly provide the service due to a high-load state caused by the concentrated accesses from the customers or a temporarily stopped state.

### SUMMARY OF THE INVENTION

To accomplish the above object, according to one aspect of the present invention, a service request agency method of surrogating a service request to a first server for providing a service corresponding to the service request obtained via a network, includes transferring via the network a service request from a client to the first server after judging that the first server is not in a state of being able to properly provide a service, making a second server obtain the transferred client's service request, retaining the obtained client's service request on a storage module, and monitoring a state of said first server, notifying the first server of the client's service request via the network that is retained on the storage module when monitoring a state of the first server and judging that the first server reverts to the state of being able to properly provide the service.

According to the present invention, even if the first server gets out of a state of being able to properly provide the service due to a high-load state caused by concentrated accesses from customers or a stopped state, the second server accepts the service request to the first sever and makes the service request to the first server in a way that surrogates the customer. Therefore, the stable service can be provided to the customer.

The service request agency method described above may further include transferring via the network the client's service request to the first server after judging that the first server is in, for instance, the high-load state, and notifying the first server of the client's service request retained in the storage module via the network if the high-load state of the first server is canceled.

With this scheme, even if the first server gets out of the state of being able to properly provide the service due to the high-load state caused by the concentrated accesses from the customers, the second server accepts the service request to the first sever and makes the service request to the first server in a way that surrogates the customer. Therefore, the stable service can be provided to the customer.

The service request agency method described above may further include transferring via the network the client's service request to the first server after judging that the first server is in a stopped state, and notifying the first server of the client's service request retained in the storage module via the network if the stopped state of the first server is canceled.

With this scheme, even if the first server gets out of the state of being able to properly provide the service due to the high-load state caused by the concentrated accesses from the customers, the second server accepts the service request to the first sever and makes the service request to the first server in a way that surrogates the customer. Therefore, the stable service can be provided to the customer.

In the service request agency method described above, the client's service request may contain product information needed by the customer and an address or phone number of the customer.

In the service request agency method described above, the client's service request may contain information needed when purchasing the product.

The service request agency method described above may further include analyzing a fluctuation in a service request count of the client's service requests retained on the storage module, of which the first server was notified, and reporting whether an extension of equipment should be done on the side of the first server on the basis of this analysis. With this scheme, it is possible to grasp a timing when an extension of the equipment on the side of the first server is implemented.

In the service request agency method described above, the client's service request may contain, for instance, a agency process category, and an agency service fee may be calculated based on the service request count of the client's service requests retaining on the storage module, of which the first server was notified, and the agency process category. With this scheme, the service fee for the second server's making the service request to the first server in a way that surrogates the customer, can be collected.

The service request agency method described above may further include analyzing a fluctuation in the agency service fee for the first server by referring to the service request count o the client's service requests retained on the storage module, of which the first server was notified, and the calculated agency service fee, and reporting whether the extension of the equipment should be done on the side of the first server on the basis of this analysis. With this scheme, it is possible to grasp the timing when the extension of the equipment on the side of the first server is implemented.

According to another aspect of the present invention, a service request agency server for surrogating a service request to a first server for providing a service corresponding to the service request obtained via a network, includes an acquisition module acquiring a service request from a client to the first server after judging that the first server is not in a state of being able to properly provide a service, a storage module retaining the client's service request acquired by the acquisition module, and a notifying module notifying the first server of the client's service request via a network that is retained on the storage module when judging that the first server reverts to the state of being able to properly provide the service.

According to the present invention, even if the first server gets out of the state of being able to properly provide the service due to the high-load state caused by the concentrated accesses from the customers or a stopped state, the second server accepts the service request to the first sever and makes the service request to the first server in a way that surrogates the customer. Therefore, the stable service can be provided to the customer.

According to still another aspect of the present invention, a service request agency system for surrogating a service request to a first server for providing a service corresponding to the service request obtained via a network, includes a monitoring module monitoring a state of the first server, a transfer module transferring via the network a service request from a client to the first server after the monitoring module has judged that the first server is not in a state of being able to properly provide a service, and a second server acquiring the client's service request transferred by the transfer module, retaining the acquired client's service request on a storage module, and notifying the first server of the client's service request via the network that is retained on the storage module when the monitoring module judges that that the first server reverts to the state of being able to properly provide the service.

According to the present invention, even if the first server gets out of the state of being able to properly provide the service due to the high-load state caused by the concentrated accesses from the customers or the stopped state, the second server accepts the service request to the first sever and makes the service request to the first server in a way that surrogates the customer. Therefore, the stable service can be provided to the customer.

In the service request agency system described above, the monitoring module may judge, when the first server is in a high-load state, that the first server is not in a state of being able to properly provide a service and may judge, when the high-load state of the first server is canceled, that the first server reverts to the state of being able to properly provide the service.

With this scheme, even if the first server gets out of the state of being able to properly provide the service due to the high-load state caused by the concentrated accesses from the customers, the second server accepts the service request to the first sever and makes the service request to the first server in a way that surrogates the customer. Therefore, the stable service can be provided to the customer.

In the service request agency system described above, for example, the monitoring module may judge, when the first server is in a stopped state, that the first server is not in a state of being able to properly provide a service and may judge, when the stopped state of the first server is canceled, that the first server reverts to the state of being able to properly provide the service.

With this scheme, even if the first server gets out of the state of being able to properly provide the service due to the stopped state, the second server accepts the service request to the first sever and makes the service request to the first server in a way that surrogates the customer. Therefore, the stable service can be provided to the customer.

According to a further aspect of the present invention, a service request agency system includes a user terminal connected to an IP network and used by a customer for referring to product information and performing an operation of purchasing a product and so on, a Web server connected to the IP network and having a service site for providing a service to the customer, an agency server surrogating a service request given from the customer, an access control server having a server monitoring module monitoring a load of the Web server, and a network control module making the service request take a bypass to the agency server when the Web server falls into a high load, and an analysis server analyzing an agency process count and an agency service fee, and the agency server includes an agency process database retaining information indicating whether the Web server undergoes the high load or is temporarily stopped, an agency process request buffer caching the service given from the customer, a provided information list database retaining a list of information provided on each service site, an agency process operation input module inputting information of the Web server of the service site of which a contract has been previously established by an agency system administrator and information indicating whether the Web server is on its maintenance, an agency access accept module surrogation-accepting the service request from the customer, and an agency information collection accept module requesting the Web server to collect the information in place of the customer.

In the service request agency system described above, for instance, the agency server may include a process agency schema database retaining a schema of input data necessary when surrogation-accepting a service request for purchasing a product, and an agency process request module making a product purchase request etc in place of the customer to the server of the service site.

In the service request agency system described above, for instance, the agency server may include a agency process information database retaining an agency accept count for the every Web server of each service site, and the analysis server may include an agency process analysis database retaining information of an analysis target Web server, an agency process statistic database retaining an agency process count in the past, an agency process analyzing module extracting the agency accept count from the agency process information database of the agency server, and an equipment investment report module reporting the agency accept count in the past for every agency service.

In the service request agency system described above, for example, the agency server may include an agency service fee information database retaining an agency service fee, and an agency service fee calculating module calculating an agency service fee based on the agency service category and the agency accept count.

In the service request agency system described above, for instance, the agency server may include an agency service fee information database retaining the agency service fee for the every Web server of each service site, and the analysis server may include an agency process analyzing module extracting the agency service fee from the agency service fee information database of the agency server, and an equipment investment report module reporting the agency service fee in the past for every agency service.

According to a still further aspect of the present invention, an agency service in an agency system surrogation-accepting a service request from a customer when a Web server of a service site undergoes a high load or is temporarily stopped for its maintenance on the Internet, includes a procedure getting a content of what agency process service is implemented agreed upon between a service site administrator and an agency system administrator, a procedure making the agency system administrator register a Web site of the agreed service site in the agency system, and surrogation-accepting a service of the service site if the service site undergoes a high load or is temporarily stopped for a maintenance, a procedure bringing about an increase in sales to the service site administrator by accepting service requests from customers such as a product purchase request etc via an agency server, and a procedure making the agency system administrator collect agency service fees for the agency services conducted in place of the agreed service site.

The agency service described above may further include a procedure making the agency system administrator report a transition of the agency service fee for the agency service conducted in place of the agreed service site, a procedure making the agency system administrator collect an added fee from the service site administrator by reporting a transition of the agency service fee in the past, and a procedure making the service site administrator judge from a content of the report which is profitable in a future aspect, an extension of the Web servers or a continuation of the agency service.

### BRIEF DESCRIPTION OF THE DRAWINGS

FIG. 1 is an explanatory view showing an example of an outline of a system architecture of a service request agency system of the present invention;

FIG. 2 is an explanatory view showing major function blocks for actualizing the service request agency system of the present invention;

FIG. 3 is an explanatory view showing a specific architecture of the service request agency system of the present invention;

FIG. 4 is an explanatory diagram showing a data structure of an agency process database included in the service request agency system of the present invention;

FIG. 5 is an explanatory diagram showing a data structure of the agency process database included in the service request agency system of the present invention;

FIG. 6 is an explanatory diagram showing a data structure of an provided information list database included in the service request agency system of the present invention;

FIG. 7 is an explanatory diagram showing a data structure of an agency process request buffer database included in the service request agency system of the present invention;

FIG. 8 is an explanatory diagram showing a data structure of an agency process information database included in the service request agency system of the present invention;

FIG. 9 is an explanatory diagram showing a data structure of a process agency schema database included in the service request agency system of the present invention;

FIG. 10 is an explanatory diagram showing a data structure of an agency service fee information database included in the service request agency system of the present invention;

FIG. 11 is an explanatory diagram showing a data structure of an agency process analysis database included in the service request agency system of the present invention;

FIG. 12 is an explanatory diagram showing a data structure of an agency process statistic database included in the service request agency system of the present invention;

FIG. 13 is an explanatory diagram showing mainly an operation of the service request agency system of the present invention;

FIG. 14 is an explanatory diagram showing mainly an operation of an agency server included in the service request agency system;

FIG. 15 is an explanatory flowchart showing a process of an agency process operation input module included in the service request agency system of the present invention;

FIG. 16 is a diagram showing an example of a screen for inputting data to be registered on the agency process database in the service request system of the present invention;

FIG. 17 is an explanatory flowchart showing an operation of the service request agency system when a Web server 500 falls into a high-load state;

FIG. 18 is an explanatory flowchart showing a process of an agency access accept module included in the service request agency system of the present invention;

FIG. 19 is an explanatory flowchart showing a process of an agency information collection accept module included in the service request agency system of the present invention;

FIG. 20 is a diagram showing an example of a screen for a list of utilizable information displayed on a user terminal included in the service request agency system of the present invention;

FIG, 21 is an explanatory diagram showing mainly an operation of the service request agency system of the present invention;

FIG. 22 is an explanatory flowchart showing a process of an agency process request module included in the service request agency system of the present invention:

FIG. 23 is a diagram showing an example of an agency process selection screen displayed on the user terminal included in the service request agency system of the present invention;

FIG. 24 is an explanatory diagram showing an example of a schema on a process agency schema database included in the service request agency system of the present invention;

FIG. 25 is an explanatory diagram showing an example of a purchase screen displayed on the user terminal included in the service request agency system of the present invention;

FIG. 26 is an explanatory diagram showing mainly an operation of the agency server included in the service request agency system of the present invention;

FIG. 27 is an explanatory diagram showing mainly an operation of the agency server included in the service request agency system of the present invention;

FIG. 28 is an explanatory flowchart showing a process of an agency service fee calculating module included in the service request agency system of the present invention;

FIG. 29 is an explanatory diagram showing an operation of an analysis server included in the service request agency system of the present invention;

FIG. 30 is an explanatory flowchart showing a process of an agency process analyzing module included in the service request agency system of the present invention;

FIG. 31 is an explanatory flowchart showing a process of an equipment investment report module included in the service request agency system of the present invention;

FIG. 32 is a diagram showing a display example of a graph of an agency service utilizing fluctuation in the service request agency system of the present invention;

FIG. 33 is a diagram showing a display example of a graph of an agency service utilizing fee fluctuation in the service request agency system of the present invention;

FIG. 34 is an explanatory view showing a business model in the agency service;

FIG. 35 is an explanatory view showing a business model in provisioning;

FIG. 36 is an explanatory view showing an example of a prior art service request agency system; and

FIG. 37 is an explanatory view showing an example of a prior art service request agency system.

### DETAILED DESCRIPTION OF THE PREFERRED EMBODIMENTS

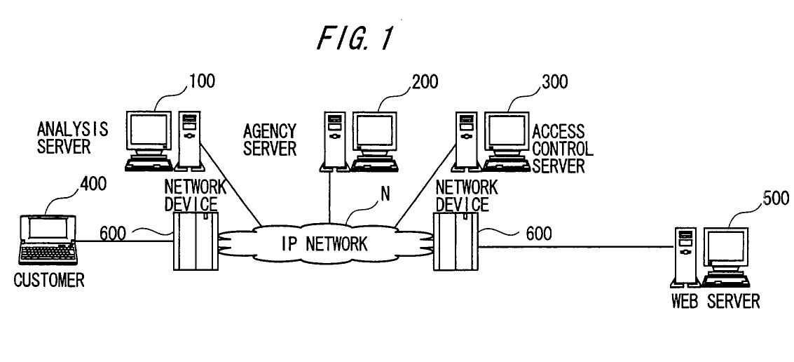

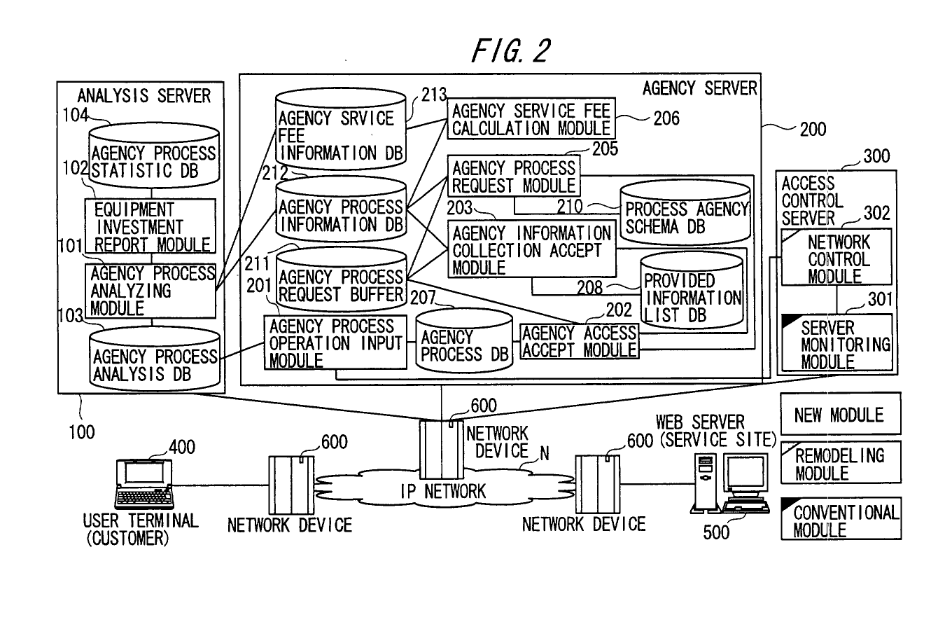

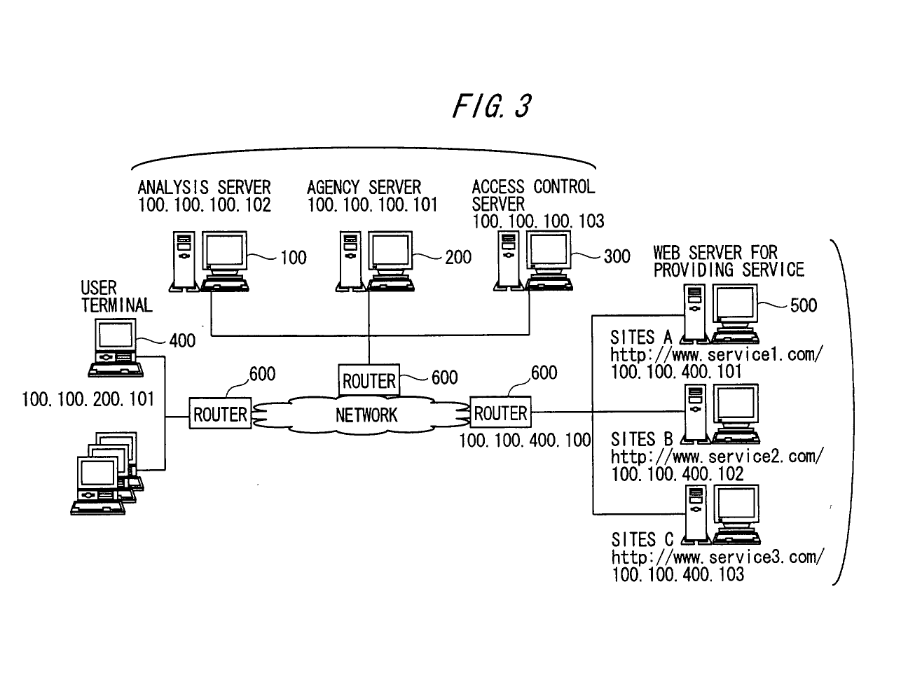

A service request agency (surrogate) system of the present invention will hereinafter be described with reference to the accompanying drawings. FIG. 1 is an explanatory view showing an outline of a system architecture of the service request agency system. FIG. 2 is an explanatory view showing function blocks of the service request agency system. FIG. 3 is an explanatory view showing a specific architecture of the service request agency system.

As shown in FIG. 1, the service request agency system includes an analysis server 100, an agency server 200, an access control server 300, a user terminal 400 (that is also called a customer), a Web server 500 and a network device 600. These devices are connected to an IP (Internet Protocol) network N such as the Internet etc, and can perform data communications with each other via the network N.

Note that a service request between the user terminal 400, the Web server 500 and the network device 600 and a service request between the user terminal 400, the agency server 200 and the network device 600, are, it is assumed, made based on HTTP (HyperText Transfer Protocol).

The analysis server 100 is defined as a computer for analyzing an agency process count and an agency service fee. As shown in FIG. 2, the analysis server 100 includes an agency process analyzing module 101, an equipment investment report module 102, an agency process analysis database (DB) 103 and an agency process statistic database (DB) 104.

The agency process analyzing module 101 serves to extract an agency/accept count of the service request to the Web server 500 from an agency process information database 212 of the agency server 200, and serves to extract an agency service fee from an agency service fee information database 213 of the agency server 200.

The equipment investment report module 102 serves to make a report of the agency/accept count in the past for each agency service, and serves to make a report of agency service fee in the past for each agency service. The agency process analysis database 103 is a database for retaining information of the analyzing target Web server 500. The agency process statistic database 104 is a database for retaining an agency process count in the past.

The agency server 200 is defined as a computer acting for a customer to make a service request. The agency server 200 functions as a second server that acquires a service request (which corresponds to an acquisition module) from the user terminal 400 that has been transferred by the network device 600 as a transfer unit (router), caches the acquired service request given from the user terminal 400 in an agency process request buffer 211 serving as a storage unit, and notifies, if a server monitoring module 301 judges that a Web state comes to a state where the service can be properly provided, the Web server 500 via the network N of the service request given from the user terminal 400 that has been cached in the agency process request buffer 211 (which corresponds to a notification module).

The agency server 200 has an agency process operation input module 201, an agency access accept module 202, an agency information collection accept module 203, an agency process request module 205, an agency service fee calculating module 206, an agency process database 207, a provided information list database 208, an process agency schema database 210, an agency process request buffer 211, an agency process information database 212 and an agency service fee information database 213.

The agency process operation input module 201 inputs (accepts) the information of the Web server of service site for which a contract has previously been made, and also information indicating whether the Web server is in the process of maintenance. The agency access accept module 202 accepts a customer's service request in a way that substitutes for the customer to make this service request to the Web server 500.

The agency information collection accept module 203 acts for the customer to request the Web server 500 to collect the information. The agency process request module 205 acts for the customer and accepts a customer's product purchase service request to the Web server 500, and acts for the customer to make the product purchase request to the Web server 500.

The agency service fee calculating module 206 calculates an agency service fee based on an agency service category and an agency/accept count. The agency process database 207 is a database for retaining information showing whether the Web server 500 of the service site undergoes a high load or is temporarily stopped.

The provided information list database 208 is a database for storing a list of the information provided by the Web server 500 (each service site). The process agency schema database 210 is a database for storing a schema of input data required when accepting, as an agency for the customer, the customer's product purchase service request to the Web server 500.

The agency process request buffer 211 is a storage unit for caching the service request given from the customer. The agency process information database 212 is a database for storing an accept count (the number of acceptances of the service requests given from the customer) of surrogation-acceptances by the agency access accept module 202 for each server 500 (each service site). The agency service fee information database 213 is a database for storing information on an agency service fee for each Web server (each service site).

The agency server 200 has a virtual Web server function. An agency virtual Web server is installed into each agency target Web server (each service site). According to the first embodiment, three agency virtual Web servers corresponding to the Web servers 500 shown in FIG. 3, are installed into the agency server 200.

The three agency virtual Web servers correspond to URLs (which might be exchanged with URIs in some cases) such as http://www.service1.com/, http://www.service2.com/ and http://www.service3.com/, respectively. Each of HTTP-based packets addressed to an IP address 100. 100. 100. 101 of the agency server 200, arrives at a request-responder agency virtual Web server determined by a URI (Uniform Resource Identifier) contained in an HTTP-based request.

The access control server 300 includes a server monitoring module 301 and a network control module 302.

The server monitoring module 301 functions as a monitoring module for monitoring a state of the Web server 500 as the first server. The server monitoring module 301 judges, for example, if the Web server 500 is in a high-load state, that the Web server 500 is in a state of being unable to properly provide the service. While on the other hand, the server monitoring module 301 judges, if the high-load state of the Web server 500 is canceled, that the Web server 500 reverts to the state of being able to properly provide the service.

Further, the server monitoring module 301 judges, for instance, if the Web server 500 is in a stopped state (temporary stop), that the Web server 500 is not in the state of being able to properly provide the service. While on the other hand, the server monitoring module 301 judges, if the stopped state (temporary stop) of the Web server 500 is canceled, that the Web server 500 comes to the state of being able to properly provide the service.

The server monitoring module 301 monitors, based on SNMP (Simple Network Management Protocol), the state of the Web server 500. The states, monitored by the server monitoring module 301, of the Web server 500 are a CPU activity ratio, a memory used capacity, a received packet count or a packet loss count and so on.

The server monitoring module 301 compares the state of the Web server 500 with a preset threshold value and judges, based on a result of this comparison, whether the monitoring target Web server 500 is in the high-load state. For example, the server monitoring module 301 judges, if the CPU activity ratio of the monitoring target Web server 500 exceeds the preset threshold value, that the Web server 500 is in the high-load state.

The network control module 302, when the server monitoring module 301 judges that the Web server 500 is in the high-load state, controls a router 600 (network control), whereby the customer's service request to the Web server 500 takes a bypass to the agency service server 200.

The user terminal 400 of the customer is an information terminal such as a personal computer etc for the customer to refer to the product information and to perform an operation for purchasing a product and so on. The user terminal 400 is connected to an Internet service provider via the network N. The network device 600 controlled by the access control server 300 in an agency service center, is provided between the Web server 500 and the user terminal 400 of the customer.

The Web server 500 is defined as a computer having a service site for providing the service to the customer. The Web server 500 functions as a first server for providing the service that meets the service request given from the user terminal 440 and acquired via the network N.

The Web server 500 includes an information providing module 501, a provided information database 502, a customer relationship management module 503 and a customer information database 504.

The Web server 500 provides one or a plurality of service sites. Each service site is given a unique IP address, whereby the user terminal 400 can access each service site and can enjoy the service.

It is assumed in the first embodiment that the service sire be provided within the network of the same Internet service provider, to which the user terminals 400 are connected. FIG. 3 shows an example where the three Web servers 500 provide three service sites. Note that one single Web server 500 may provide the three service sites.

Further, for instance, the agency service center administered by an agency service administrator or the Internet service provider, is also installed within the same network. The agency service center is constructed of the analysis server 100 (of which an IP address is 100. 100. 100. 102), the agency server 200 (of which an IP address is 100. 100. 100. 101) and the access control server 300 (of which an IP address is 100. 100. 100. 103). Note that a possible scheme is not that the analysis server 100, the agency server 200 and the access control server 300 run on the individual server computers but that all or a part of these servers 100 200, 300 run on the same server computer.

In the Web servers 500, for example, a site A (of which URL is http://www.service1.com/) is a customer support site administered by an electric product maker, and site B (of which URL is http://www.service2.com/) and a site C (of which URL is http://www.service3.com/) are e-commerce sites.

The E-commerce sites provide product information other than selling the products. The customer, when doing the e-commerce, accesses these e-commerce sites and refers to the product information. The customer, if purchasing the product the customer desires to get, performs a sure payment procedure (online settlement) by utilizing a secure interface at the same site.

The customer support site is categorized as a support general site, and provides a variety of manuals and update information etc as well as accepting repairs. The customer, after purchasing the product of the maker, accesses this customer support site in order to obtain the detailed information of the product and setting cases, then searches for related materials and downloads these components. Further, software update information and advertisement information on new product/new accessories are browsed on this customer support site. Therefore, the customer support site is periodically accessed, and, besides, concentrated accesses to this site occur due to troubles of the products and updating the software to acquire new functions.

The network device 600 functions as a transfer unit (router) for transferring via the network N a service request (addressed to the Web server 500) to the Web server 500 from the user terminal 400 after the server monitoring module 301 has judged that the Web server 500 is not in the state of being able to properly provide the service.

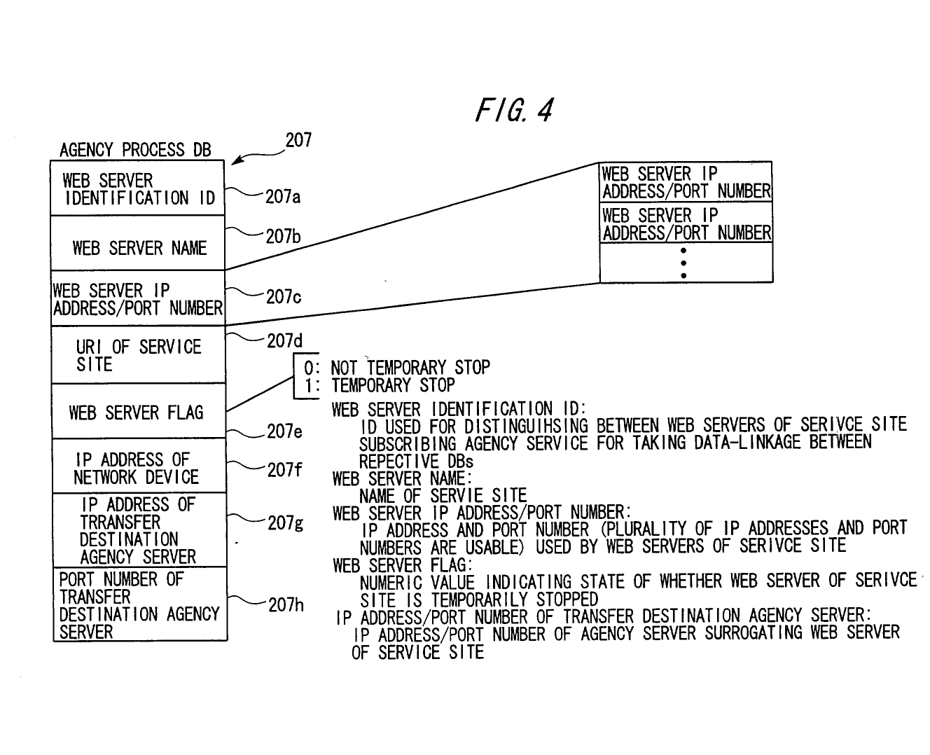

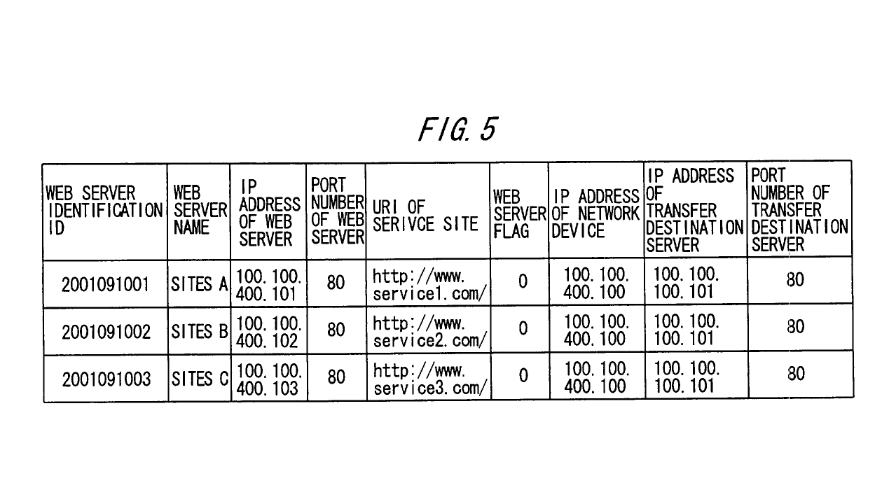

Next, the data tables will be explained with reference to the drawings. FIG. 4 shows a data structure of the agency process database 207. FIG. 5 shows a specific example of the data actually set on the agency process database 207.

The agency process database 207 is a (table-formatted) database consisting of (fields such as) a server identification ID 207a of the Web server of the service site that subscribes the agency service, an (unique) IP address/port number 207c used by the Web server of this service site, an URI (Uniform Resource Identifier) 207d of the service site, a flag (numeric value) 207e indicating a state of whether the Web server of the service site is temporarily stopped, an IP address 207f of the network device on the side of the Web server of the service site, and an (unique) IP address 207g (100. 100. 10. 101 in FIG. 3) and a port number 207h (port No. 80 in FIG. 3) that are used by the agency server as a transfer destination.

The server identifications ID 207a of the Web servers are used for distinguishing between the Web servers for taking a linkage between the databases. The web server identification ID 207a consists of an agency service accept date and an accept number on this accept date. There may be set a plurality of IP addresses/port numbers 1207c used by the service site web servers 500.

In the case of the Web server utilizing a DNS (Domain Name System)-based distributed server system, a pair of IP address and port number are set in this IP address/port number field. Supposing that the IP address of the Web server 500 of the service site is 100. 100. 400. 101 and the port number thereof is 80 as an http default port number, a piece of data “100. 100. 400. 101:80” is set in the IP address/port number field 207c for the Web server 500 of the service sire.

The service site Web server flag 207e indicates a state of whether the Web server is stopped by the administrator. For instance, if the Web server is temporarily stopped, “1” is set in the service site Web server flag 207e, whereas if not, “0” is set therein.

The IP address 207f of the network device on the side of the service site Web server 500 is a piece of information used for traffic control of the access control server 300. The IP address 207f of the network device is an IP address of the router 600 as a network traffic control target through the service site Web server.

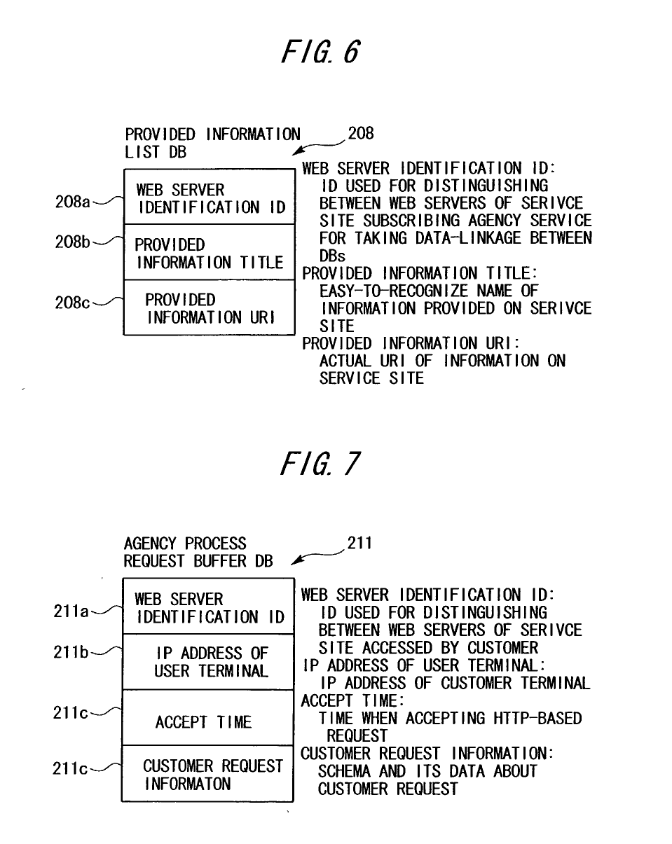

FIG. 6 shows a data structure of the provided information list database 208. The provided information list database 208 consists of a service identification ID 208a of the service site Web server, a provided information title 208b of the information provided on that service site, and a provided information URI 208c of the provided information.

The server identification ID 208a of the server site Web server is used for distinguishing between the Web servers for taking a linkage between the databases such as the agency process database 207. The provided information title 208b is descriptive enough for the customer to be easily understandable such as “product information” and so on. The provided information URI 208c is a field in which to set a provided information URI from which the information needed by the customer is known during the agency service and of which the customer relationship management module of the service site Web server needs to be informed.

FIG. 7 shows a data structure of the agency process request buffer database 211. The agency process request buffer database 211 consists of a Web server identification ID 211a, a user terminal IP address 211b, an accept time 211c at which the HTTP-based request containing URI is accepted, and customer request information 211d. In the case of a port number other than the default port number (port No. 80), URI contains a piece of port number information. For example, when the port number is 8000, this port number is set in URI such as http://www.service1.com:800/. The accept time is used for determining a service accept order on the basis of the buffer 211.

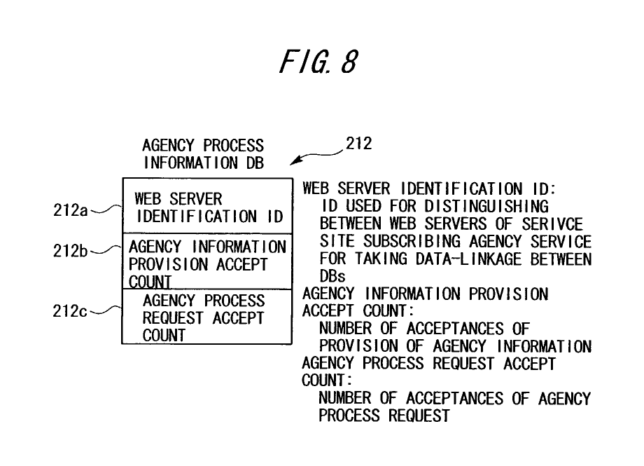

FIG. 8 shows a data structure of the agency process information database 212. The agency process information database 212 consists of a server identification ID 212a of the server site Web server, an agency information provision accept count 212b defined as an accept count of accepting the provision of the agency information, and an agency process request accept count 212c defined as a accept count of accepting the agency process request. The agency service is categorized into an agency information providing service and an agency process request service. For reporting and accounting, respective service utilizing counts are set intact as the numeric values in the agency information provision accept count field 212b and the agency process request accept count field 212c.

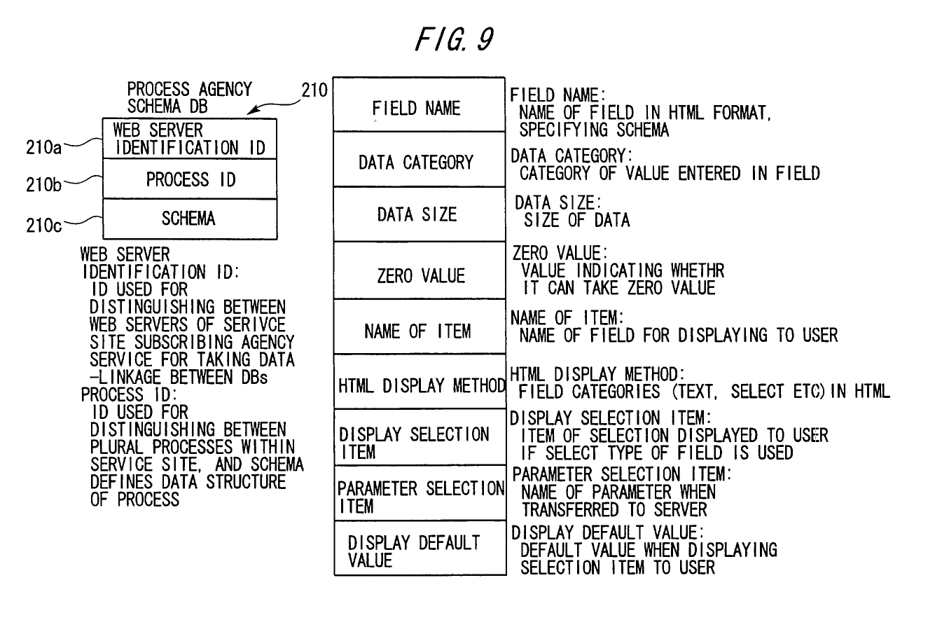

FIG. 9 shows a data structure of the process agency schema database 210. The process agency schema database 210 consists of a server identification ID 210a of the server site Web server, a process ID 210b for distinguishing between a plurality of processes within the server site, and a schema 210c that defines a data structure of the process.

A plurality of processes may be surrogated on the service site in some cases. Therefore, the process ID 210c is sued for distinguishing between the processes, and the process IDs are unique numerals determined by the agency service administrator.

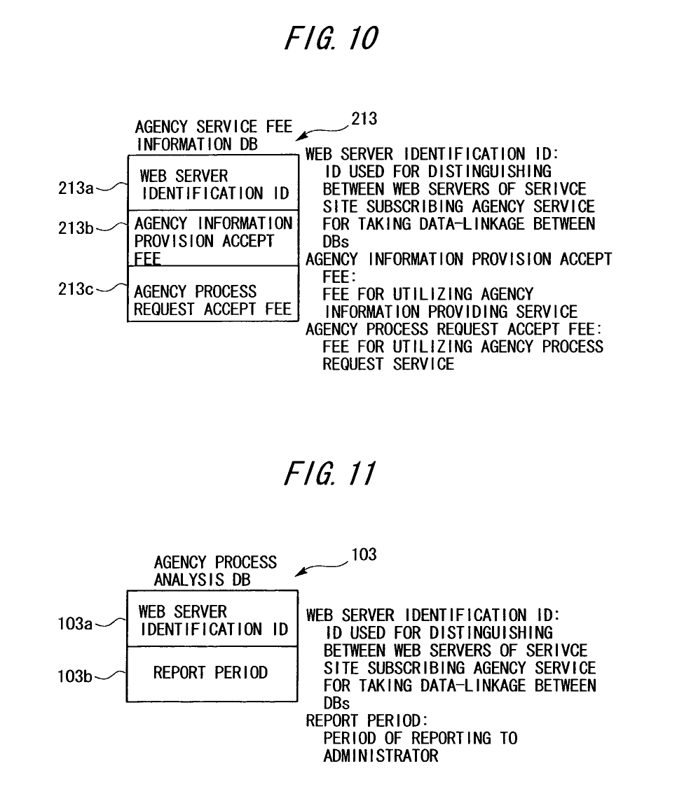

FIG. 10 shows a data structure of the agency service fee information database 213. The agency service fee information database 213 consists of a server identification ID 213a of the server site Web server, an agency information provision accept fee 213b as a fee for utilizing the agency information providing service, and an agency process request accept fee 213c as a fee for utilizing the agency process request service.

The fees for utilizing he agency information provision service and the agency process request service are added up during a report period of the agency process analysis database 103, and the numerical values of the total fees in Yen are set in the agency information provision accept fee field 213b and the agency process request accept fee field 213c, respectively.

FIG. 11 shows a data structure of the agency process analysis database 103. The agency process analysis database 103 consists of a server identification ID 103a of the server site Web server and a report period 103b. The report period is described on a day-basis, wherein when setting the report period to one week, “7” is set in the report period field 103b.

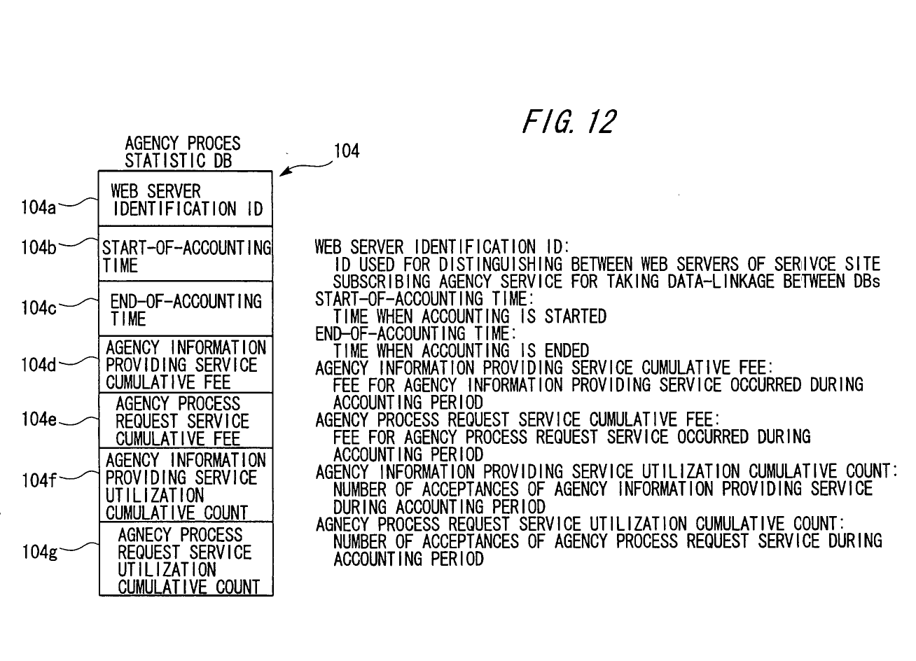

FIG. 12 shows a data structure of the agency process statistic database 104. The agency process statistic database 104 consists of a server identification ID 104a of the server site Web server, a start-of-accounting time 104b indicating a start of accounting, an end-of-accounting time 104c indicating an end of accounting, an agency information providing service cumulative fee 104d cumulated during the accounting period, an agency process request service cumulative fee 104e cumulated during the accounting period, an agency information providing service utilization cumulative count 104f indicating the number of the services accepted in the agency service during the accounting period, and an agency process request service utilization cumulative count 104g indicating the number of the services accepted in the agency service during the accounting period.

The start-of-accounting time 104b showing the start of accounting is also a start time of the report period and consists of a date and a time such as Dec. 9, 2001 13:08. The end-of-accounting time 104 has the same data structure.

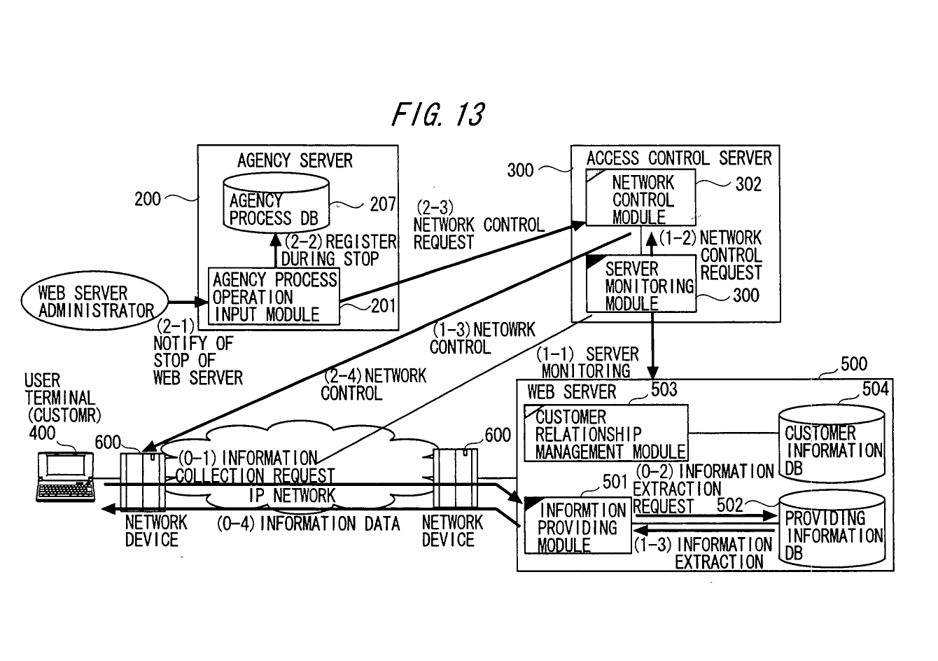

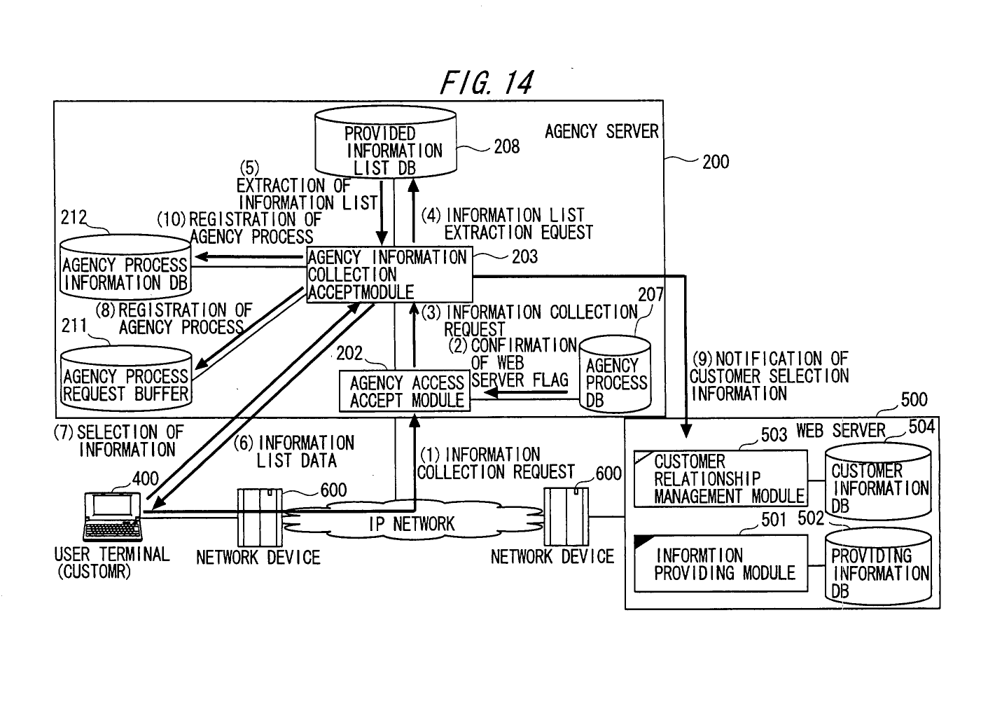

Next, an operation of the service request agency system having the architecture described above will be explained with reference to the drawings. FIG. 13 is an explanatory diagram showing the operation of the service request agency system. FIG. 14 is an explanatory diagram showing mainly an operation of the agency server embraced in the service request agency system.

(Serviceable State of Web Server 500)

Given herein is an explanation of an operation of the service request agency system when the Web server 500 is in the state of being able to properly provide the service, i.e., when the Web server 500 is neither in the high-load state due to the concentrated accessed from the customers nor in the temporarily stopped state.

As shown in FIG. 13, the customer, when collecting pieces of product information etc retained by the Web server 500 of the service site, makes a service request to the Web server 500 through the user terminal 400 thereof so that the Web server 500 collect the information (0-1). The Web server 500 receiving the service request from the customer indicates the information providing module 501 to extract the information corresponding to the service request out of the provided information database 502 (0-2), (0-3). The information providing module 501 transmits the thus extracted information to the user terminal 400 (of the customer) (0-4). Note that the same as above is carried out also when the customer makes a process request as a service request to the Web server 500 to purchase a product and so on.

(Unserviceable State of Web Server 500)

Given herein is an explanation of an operation of the service request agency system when the Web server 500 is not in the state of being able to properly provide the service, i.e., when the Web server 500 is in the high-load state due to the concentrated accessed from the customers or in the temporarily stopped state.

(High-Load State of Web Server 500)

As shown in FIG. 13, the server monitoring module 301 of the access control server 300 always monitors an operation state of the Web server 500 registered in the IP address/port number field 207c of the agency process database 207 (1-1). The network control module 302 of the access control server 300 controls the router 600 so that the service request given from the user terminal 400 to the Web server 500 after the server monitoring module 301 has judged that the Web server 500 and the network N fall into the high-load state, is transferred (detoured) to the agency server 200 (network control).

To be specific, the server monitoring module 301, when judging that the Web server 500 and the network N fall into the high-load state, requests the network control module 302 to executes the network control (1-2). The network control module 302 receiving the network control request executes the network control based on this network control request (1-3). For example, the network control module 302 receiving the network control request transmits a specified control command to the control target router 600 (registered in the network device IP address field 207f of the agency process database 207) (1-3).

The router 600 receiving this control command starts a process of relabeling the destination IP address of a received packet addressed to the Web server 500 with an IP address of the agency server 200, and forwarding the relabeled packet from the port thereof.

(Temporarily Stopped State of Web Server 500)

As illustrated in FIG. 13, the Web server administrator, when temporarily stopping the Web server 500, sets the data (e.g., “1”) indicating that the Web server 500 is temporarily stopped, in the Web server flag 207e of the agency process database 207 (2-1, (2-2). This setting is done through the agency process operation input module 201 of the agency server 200.

When setting the data (“1”) indicating that the Web server 500 is temporarily stopped, the agency process operation input module 201 requests the network control module 302 to perform the network control (2-3). The network control module 302 receiving the network control request issues a specified control command to the control target router 600 (registered in the network device IP address field 207f of the agency process database 207) (2-4).

The router 600 receiving this control command starts a process of relabeling the destination IP address of a received packet addressed to the Web server 500 with an IP address of the agency server 200, and forwarding the relabeled packet from the port thereof.

(Agency Process When Given Information Collection Request As Service Request)

Next, an agency process when given an information collection request as a service request, will be explained. As discussed above, if the Web server 500 falls into the high-load state or the temporarily stopped state, the network control is carried out. With this network control done, as shown in FIG. 14, it is possible to transfer to the agency server 200 the information collection request (contained in an IP packet or a network packet) as the service request given from the user terminal 400 to the Web server 500 after judging that the Web server 500 and the network N fall into the high-load state or the temporarily stopped state (1).

The agency access accept module 202 of The agency server 200 obtains (accepts) the service request forwarded from the router 600. Generally, the HTTP-based service request contains URI of the Web server that the user terminal 400 is to access. Therefore, the agency access accept module 202 can determine the site (i.e., the Web server by which the service request should be surrogated) by referring to URL etc contained in the service request.

The agency access accept module 202, when accepting the information collection request as the service request from the customer, judges whether the Web server 500 that should surrogate the accepted service request remains temporarily stopped. This judgement can be made by referring to the Web server flag 207e of the agency process database 207 (2).

The agency access accept module 202, when judging that the Web server 500 that should surrogate the accepted service request remains temporarily stopped, requests the agency information collection accept module 203 to collect the information including the data (“1”) indicating that this Web server 500 is temporarily stopped (3).

The agency information collection accept module 203 extracts from the provided information list database 208 a list of information provided on the site that the user terminal 400 is to access (4), (5). The extracted information list is transmitted to the user terminal 400 (6). The customer selects a desired item of information from the information list, and sends a request for acquiring the selected information as a service request back to the agency information collection accept module 203 (7).

The agency information collection accept module 203 accepting the request sent back therefrom retains the service request (the selected information acquisition request) given from the customer in the agency process request buffer 211 (8). Then, the agency information collection accept module 203, if the server monitoring module 301 judges that the temporarily stopped state of the Web server 500 is canceled, reads the customer's service request from the agency process request buffer 2112, and sends the readout service request to the customer relationship management module 503 of the Web server 500 (9). Thereafter, the Web server 500 comes to execute the same process as in the case of receiving the service request (the information collection request) directly from the user terminal 400.

Further, the agency information collection accept module 203 registers in the agency process information database 212 a piece of information indicating that the information collection process as an agency process has been executed in place of the service site (10).

In the way described above, the agency server 200 is capable of accepting the information (the information acquisition request to the Web server) needed by the customer even when the Web server 500 is in the high-load state or the temporarily stopped state. Accordingly, even if the Web server 500 is not in the state of being able to properly provide the service due to the high-load state caused by the concentrated accesses from the customers or due to the stopped state, the service can be stably provided to the customer.

Next, the operation (the agency process when receiving the information collection request as the service request) of the service request agency system, will be described in greater detail.

(1) Contract of Agency Information Providing Service

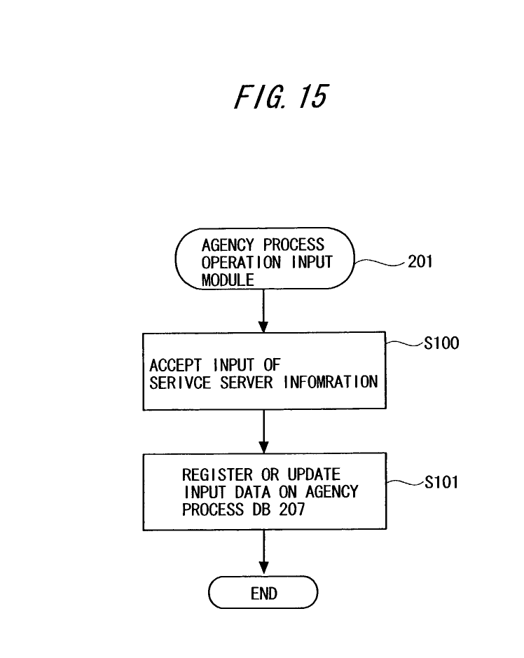

FIG. 15 is an explanatory flowchart showing a process of the agency process operation input module 201. An accept of the agency access will hereinafter be explained in depth with reference to the flowchart in FIG. 15.

The service site administrator, if there were the user accesses over an allowable capacity of the Web server 500 or when predicting that the over-accessing will occur in the future, applies the agency service administrator for utilizing the agency service and makes a contract of the agency service.

In this case, the service site administrator making the application for utilizing the agency service notifies the agency service administrator of the Web server IP address/port number and URI (URL) (http://www.service1.com/) of the service site administered by the site-A administrator as pieces of information on the administrator's service site.

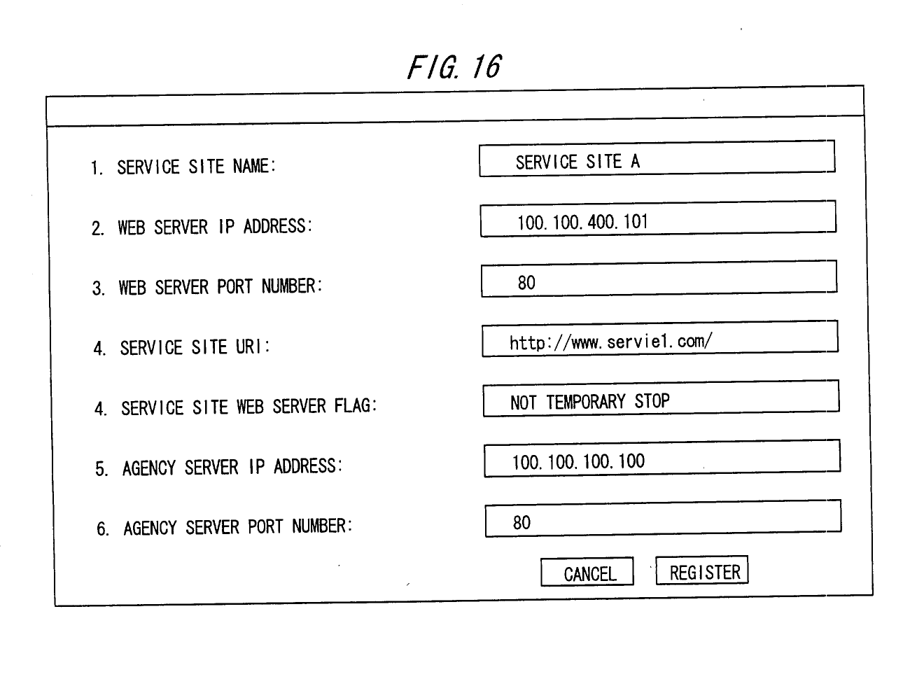

The agency service administrator determines the agency server for the customer, which corresponds to the Web server 500, and prepares an IP address/port number of this agency server. The agency service administrator displays a registration screen (FIG. 16) by booting GUI (Graphical User Interface) etc from on a predetermined terminal, and inputs those pieces of information through on the registration screen to the agency server 200.

The agency process operation input module 201 of the agency server 200 accepts the inputted information (S100), and stores the same information on the agency process database 207 (S101). FIG. 5 is a view showing the agency process database 207 when pieces of information of the three service site Web servers illustrated in FIG. 3 are inputted.

(2) Start of Agency Information Providing Service

As described above, if the Web server 500 falls into the high-load state or the temporarily stopped state, the network control is carried out. This scheme makes it possible to transfer to the agency server 200 the service request given from the user terminal 400 to the Web server 500 after judging that the Web server 500 and the network N fall into the high-load state or the temporarily stopped state.

The transfer to the agency server 200 will be described by exemplifying a case where there occurs a trouble about security of a product made by the electric product maker defined as the administrator of the service site A, and the details of the security trouble are provided on the service site A (http://www.service1.com/).

In this case, the majority of customers, for browsing the details of the security trouble, inputs the URL such as http://www.service1.com/ on the Browser running on the user terminals 400, thus accessing the HTTP-based service site A. It is therefore assumed that the concentrated accesses to the service site A occur.

Hence, a high load is applied on the Web server 500, and from this point of time it is impossible to satisfy a certain level of QoS (Quality of Service) of a newly-occurred service request (the information collection request) from the user terminal 400 to the Web server 500. Namely, the Web server 500 falls into a state of being unable to properly provide the service in response to the service request.

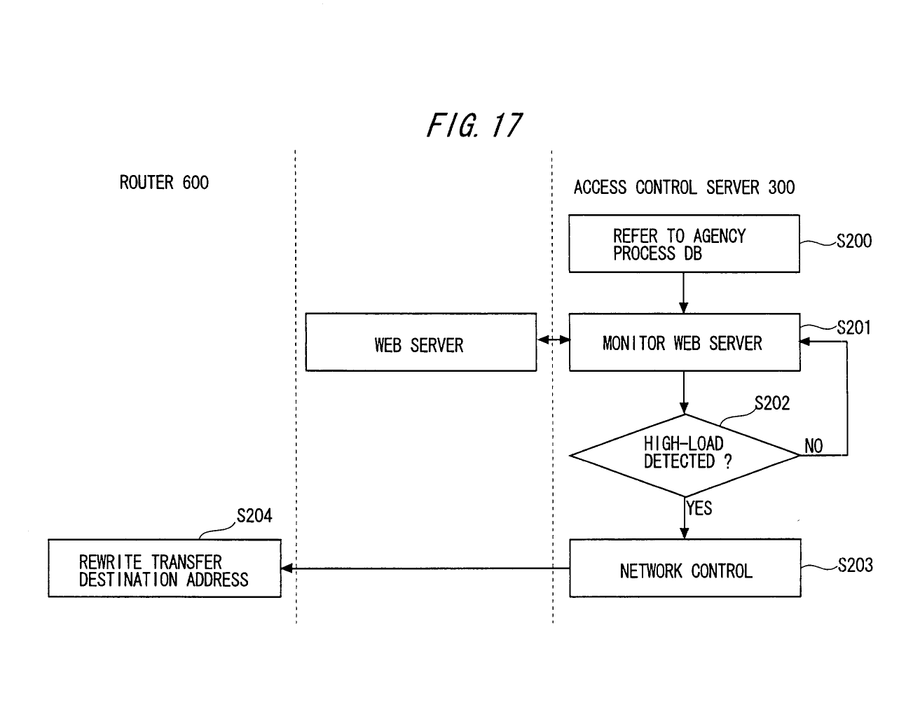

An operation of the case of the Web server 500 thus falling into the high-load state, will be explained referring to FIG. 17. FIG. 17 is an explanatory flowchart showing an operation of the service request agency system when the Web server 500 gets into the high-load state.

As shown in FIG. 17, the access control server 300 refers to the agency process database 212 (S200), and always monitors an operating state of the monitoring target Web server 500 (S201). Accordingly, when judging that the Web server 500 falls into the high-load state (S202; Yes), the access control server 300 performs the network control of the router 600 (S203, S204), whereby the HTTP-based service request for the service site A can be forwarded to the agency server 200 since then. That is, the service request (IP packet) from the user 400 to the Web server 500 after judging that the Web server 500 comes to the high-load state, can be forwarded to the agency server 200.

Note that if the server monitoring module 301 judges that the high-load state of the Web server 500 is canceled, the access control server 300 indicates the network control module 302 to control the router 600 in order to forward to the Web server 500 the service request (IP packet) from the user terminal 400 to the Web server 500.

To be more specific, when judging that the high-load state of the Web server 500 is canceled, the access control server 300 indicates the network control module 302 to transmit a specified control command to the control target router 600. The router 600 receiving this control command forwards the received packet IP-addressed to the Web server 500 from a predetermined port without relabeling this destination IP address with an IP address of the agency server 200.

This scheme makes it possible to transfer to the Web server 500 the service request (IP packet) given from the user terminal 400 to the Web server 500 after judging that the high-load state of the Web server 500 is canceled.

(3) Implementation of Agency Information Providing Service

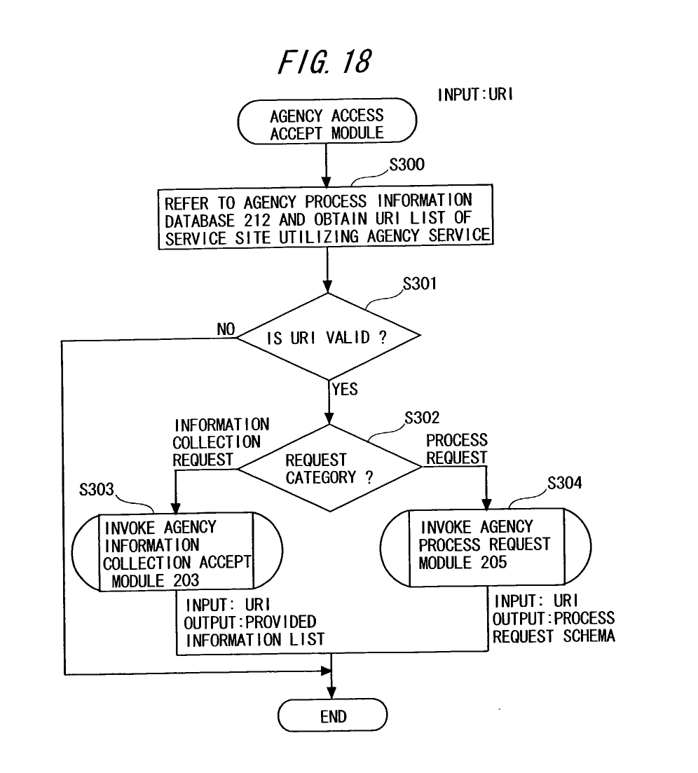

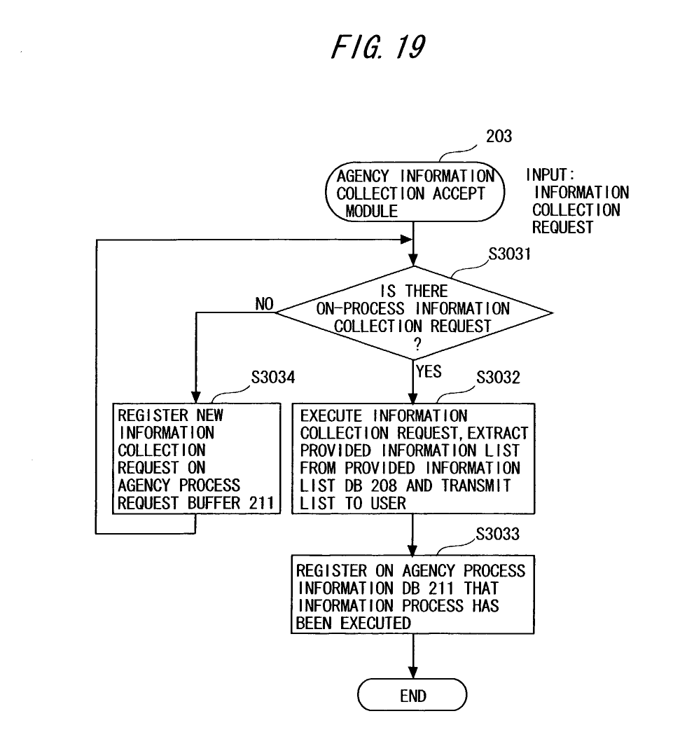

FIG. 18 is an explanatory flowchart showing a process of the agency access accept module 202. FIG. 19 is an explanatory flowchart showing a process of the agency information collection accept module 203. An implementation of the agency information providing service will be explained referring to these two flowcharts.

After judging that the Web server 500 gets into the high-load state, it is assumed that the HTTP-based service request (network packet) addressed to an IP address “100. 100. 400. 101” of the Web server 500 having fallen into the high-load state, this request being given from the user terminal 400 of the customer, arrives at the router 600 on the side of the service site.

The router 600 on the side of the service site is structured to relabel the address by use of the access control server 300, and hence the network packet addressed to the IP address “100. 100. 400. 101” is relabeled with an IP address “100. 100. 100. 101” unique to the agency server 200 and then forwarded (i.e., transferred) from the port concerned.

The Browser on the user terminal 400 of the customer has issued the HTTP-based request linked to the URI (URL) such as http://www.service1.com/, and therefore the agency server 200 determines an in-charge agency virtual Web server specified by this URI. Herein, the agency server 200 obtains a URI list of the agency service subscriber site that is stored on the agency process database 207, then compares the URI contained in the HTTP-based request sent from the user terminal 400 of the customer with this URI list, and judges whether the URI contained in the HTTP-based request sent therefrom comes under a category of the service site subscribing the agency service (S301). Herein, the URI comes under the category of the service site A subscribing the agency service, and hence the processing advances to S302.

Next, the agency access accept module 202 judges a category of the agency service request (S302). Herein, the service request from the user terminal 400 is an information collection request, and therefore the processing diverts to S303. Then, the agency access accept module 202, in response to the information collection request from the user terminal 400 to the URL http://www.service1.com/, invokes the agency information collection accept module 203 of the agency server 200 (S303).

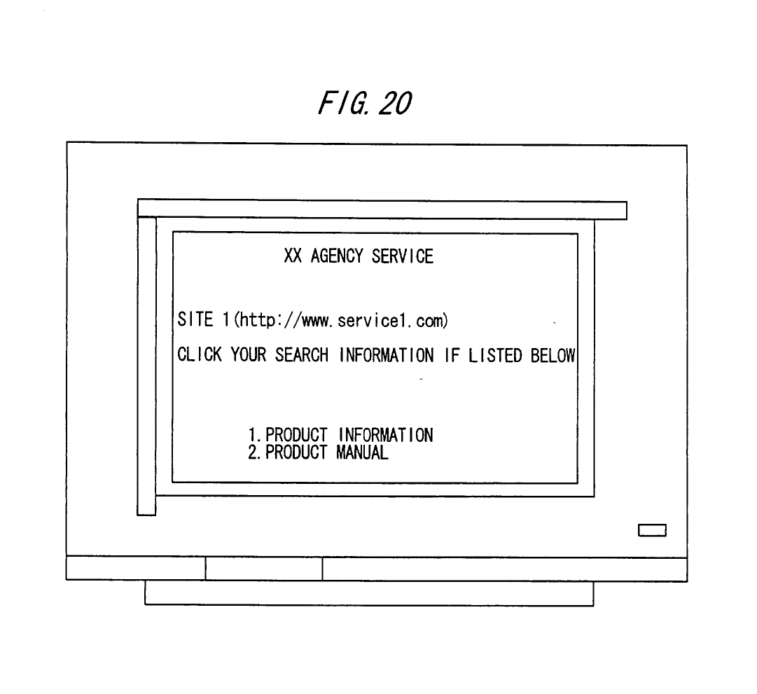

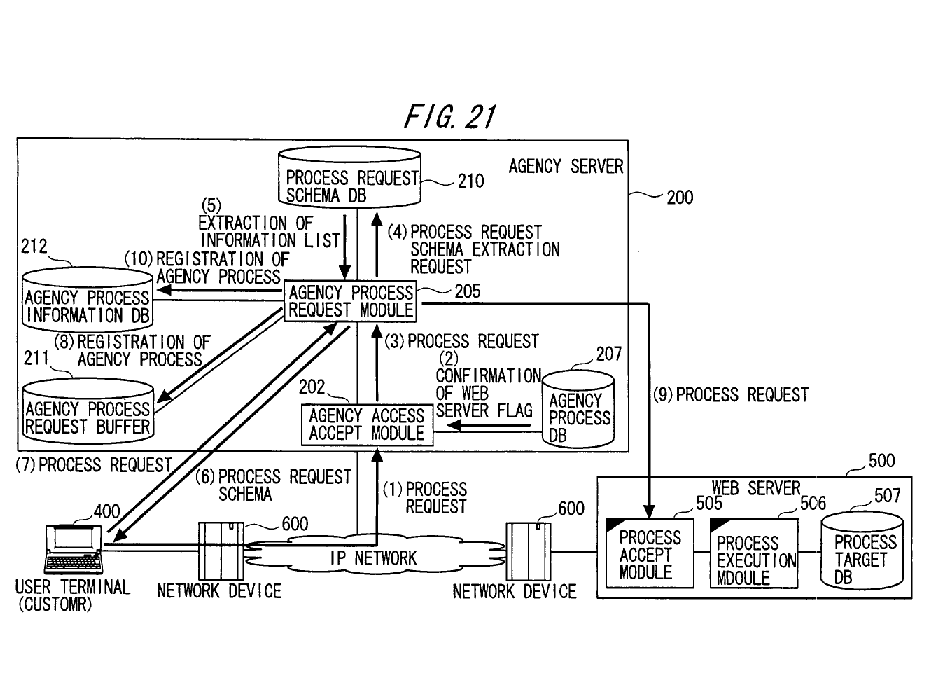

As shown in FIG. 19, the agency information collection accept module 203 invoked at first judges whether there is an in-process agency information providing request (S3031). When judging that there is no in-process agency information providing request (S3031: No), the processing advances to S3032. Then, the agency information collection accept module 203 refers to the agency information collection list database 208 of the service site A to extract a list of utilizable information from the database 208, and transmits this HTML- or JavaScript-formatted information list to the user terminal 400, wherein the thus formatted information list is displayed by the Browser on the user terminal 400 as illustrated in FIG. 20 (S3032).

The customer browses the list of the information substantially utilizable on the service site and, if the information to be obtained by linking to http://ww/service1.com/ is contained in the list, clicks this target item (the category of information). The information of the item clicked is transmitted to the agency information collection accept module 203 by a method such as HTTP-based POST.

The agency information collection accept module 203 transmits the item information based on HTTP to the customer relation management module 503 of the Web server 500. Further, the agency information collection accept module 203 registers on the agency process information database 212 a piece of information indicating that the customer desires to obtain the item information, time information at this time and customer information (S3033).

(Agency Process When Receiving Process Request As Service Request Such As Purchasing Product etc)

Given next is an explanation of an agency process when receiving a process request as a service request such as purchasing a product etc. As described above, if the Web server 500 falls into the high-load state or the temporarily stopped state, the network control is executed. This scheme makes it possible, as shown in FIG. 21, to transfer to the agency server 200 the process request contained in the IP packet or the network packet) as the service request given from the user terminal 400 to the Web server 500 after judging that the Web server 500 and the network N fall into the high-load state or the temporarily stopped state (1).

The agency access accept module 202 of the agency server 200 obtains (accepts) the service request forwarded from the router 600. Generally, the HHTP-based service request contains the URI of the Web server that the user terminal 400 is to access. Therefore, the agency access accept module 202 refers to the URL etc contained in the service request, thereby determining the site (i.e., the Web server that should surrogate the service request) that the user terminal 400 is to access.

The agency access accept module 202, when accepting the process request as the customer's service request such as purchasing the product etc, judges whether the Web server 500 that should surrogate the accepted service request remains temporarily stopped. This judgement can be made by referring the Web server flag 207e in the agency process database 207 (2).

The agency access accept module 202, when judging that the Web server 500 that should surrogate the accepted service request remains temporarily stopped, makes the agency process request to the agency process request module 205, including the information indicating that the Web server 500 remains temporarily stopped (3).

The agency process request module 205 extracts, from the process request schema database 210, a process request schema containing input items (fields) necessary for purchasing the product etc provided on the service site that the user terminal 400 is to access (4), (5). The extracted process request schema is sent to the user terminal 400 (6). The customer inputs pieces of information (required when purchasing the product, such as product information needed by the customer, a customer's address or phone number and so on) in the input items specified, and sends the process request containing the information-inputted items (data-entered fields) as the service request such as purchasing the product etc back to the agency process request module 205 (7).

The agency process request module 205 accepting the process request (containing the information-inputted items, such as purchasing the product etc) sent back retains this customer's service request on the agency process request buffer (database) 211 (8). Then, the agency process request module 205, if the server monitoring module 301 etc judges that the temporarily stopped state of the Web server 500 is canceled, reads the customer's service request from the agency process request buffer (database) 211, and sends the readout service request to the process accept module 505 of the Web server 500 (9). Hereafter, it follows that the Web server 500 executes the same process as in the case of receiving the service request (containing the information-inputted items, such as purchasing the product etc) directly from the user terminal 400.

Further, the agency process request module 205 registers on the agency process information database 212 a piece of information indicating that the agency process has been accepted in place of the service site (10).

As described above, even if the Web server 500 is in the high-load state or the temporarily stopped state, the agency server 200 is capable of accepting the information(the process request to the Web server) needed by the customer. Accordingly, even if the Web server 500 is not in the state of being able to properly provide the service due to the high-load state caused by the concentrated accesses from the customers or due to the stopped state, the service can be stably provided to the customer.

Next, the operation (the agency process when receiving the process request as the service request such as purchasing the product etc) of the service request agency system, will be discussed in greater detail.

Contract of Agency Information Providing Service

FIG. 15 is an explanatory flowchart showing a process of the agency process operation input module 201. An agency access accept process will hereinafter be explained with reference to this flowchart.

The service site administrator, if there were the user accesses over an allowable capacity of the Web server 500 or when predicting that the over-access will occur in the future, applies the agency service administrator for utilizing the agency service and makes a contract of the agency service.

In this case, the service site administrator making the application for utilizing the agency service notifies the agency service administrator of the Web server IP address/port number and URI (URL) (http://www.service2.com/) of the service site administered by a site-B administrator as pieces of information on the administrator's service site, and also a schema of the respective processes to be surrogated.

The agency service administrator determines the agency server for the customer, which corresponds to the Web server 500, and prepares an IP address/port number of this agency server. The agency service administrator displays the registration screen (FIG. 16) by booting GUI (Graphical User Interface) etc from on a predetermined terminal, and inputs those pieces of information through on the registration screen to the agency server 200. The agency process operation input module 201 of the agency server 200 accepts the inputted information (S100), and stores the same information on the agency process database 207 (S101). FIG. 5 is the view showing the agency process database 207 when pieces of information of the three service site Web servers illustrated in FIG. 3 are inputted.

(2) Start of Agency Information Providing Service

As described above, if the Web server 500 falls into the high-load state or the temporarily stopped state, the network control is carried out. This scheme makes it possible to transfer to the agency server 200 the service request given from the user terminal 400 to the Web server 500 after judging that the Web server 500 and the network N fall into the high-load state or the temporarily stopped state.

The transfer to the agency server 200 will be described by exemplifying a case where the details of purchasing a new product made by the electric product maker defined as the administrator of the service site B are provided on the service site B (http://www.service2.com/).

In this case, the majority of customers, for purchasing the new products, inputs the URL such as http://www.service2.com/ on the Browser running on the user terminals 400, thus accessing the HTTP-based service site B. It is therefore assumed that the concentrated accesses to the service site B occur.

Hence, a high load is applied on the Web server 500, and from this point of time it is impossible to satisfy a certain level of QoS (Quality of Service) of a newly-occurred service request (a process request such as purchasing the product etc) from the user terminal 400 to the Web server 500. Namely, the Web server 500 falls into a state of being unable to properly provide the service in response to the service request.

An operation of the case of the Web server 500 thus falling into the high-load state, will be explained referring to FIG. 17. As shown in FIG. 17, the access control server 300 refers to the agency process database 212 (S200), and always monitors an operating state of the monitoring target Web server 500 (S201).

Accordingly, when judging that the Web server 500 falls into the high-load state (S202; Yes), the access control server 300 performs the network control of the router 600 (S203, S204), whereby the HTTP-based service request for the service site B can be forwarded to the agency server 200 since then. That is, the service request (IP packet) from the user 400 to the Web server 500 after judging that the Web server 500 comes to the high-load state, can be forwarded to the agency server 200.

Note that if the server monitoring module 301 judges that the high-load state of the Web server 500 is canceled, the access control server 300 indicates the network control module 302 to control the router 600 in order to forward to the Web server 500 the service request (IP packet) from the user terminal 400 to the Web server 500.

To be more specific, when judging that the high-load state of the Web server 500 is canceled, the access control server 300 indicates the network control module 302 to transmit a specified control command to the control target router 600. The router 600 receiving this control command forwards the received packet IP-addressed to the Web server 500 from a predetermined port without relabeling this destination IP address with an IP address of the agency server 200.

This scheme makes it possible to transfer to the Web server 500 the service request (IP packet) given from the user terminal 400 to the Web server 500 after judging that the high-load state of the Web server 500 is canceled.

(3) Implementation of Agency Information Providing Service

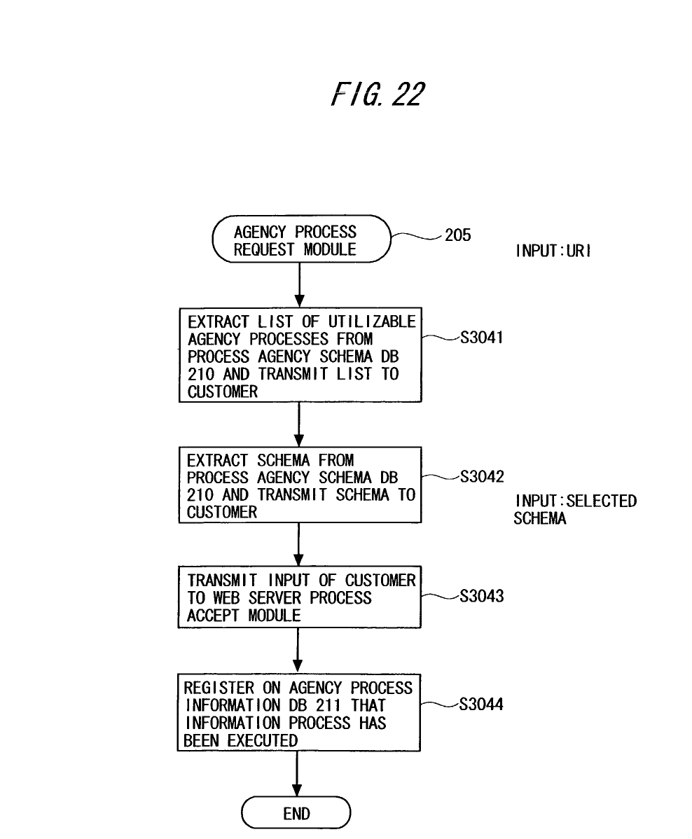

FIG. 22 is an explanatory flowchart showing a process of the agency process request module 205. An agency access accept process will be explained referring to these flowcharts in FIGS. 22 and 18.

After judging that the Web server 500 gets into the high-load state, it is assumed that the HTTP-based service request (network packet) addressed to an IP address “100. 100. 400. 102” of the Web server 500 having fallen into the high-load state, this request being given from the user terminal 400 of the customer, arrives at the router 600 on the side of the service site.

The router 600 on the side of the service site is structured to relabel the address by use of the access control server 300, and hence the network packet addressed to the IP address “100. 100. 400. 102” is relabeled with an IP address “100. 100. 100. 101” unique to the agency server 200 and then forwarded (i.e., transferred) from the port concerned.

The Browser on the user terminal 400 of the customer has issued the HTTP-based request linked to the URI (URL) such as http://www.service2.com/ and therefore the agency server 200 determines an in-charge agency virtual Web server specified by this URI. Herein, the agency server 200 obtains a URI list of the agency service subscriber site that is stored on the agency process database 207, then compares the URI contained in the HTTP-based request sent from the user terminal 400 of the customer with this URI list, and judges whether the URI contained in the HTTP-based request sent therefrom comes under a category of the service site subscribing the agency service (S301). Herein, the URI comes under the category of the service site B subscribing the agency service, and hence the processing advances to S302.

Next, the agency access accept module 202 judges a category of the agency service request (S302). Herein, the service request from the user terminal 400 is a process request, and therefore the processing diverts to S304. Then, the agency access accept module 202, in response to the process request from the user terminal 400 to the URL http://www.service2.com/, invokes the agency process request module 205 of the agency server 200 (S304).

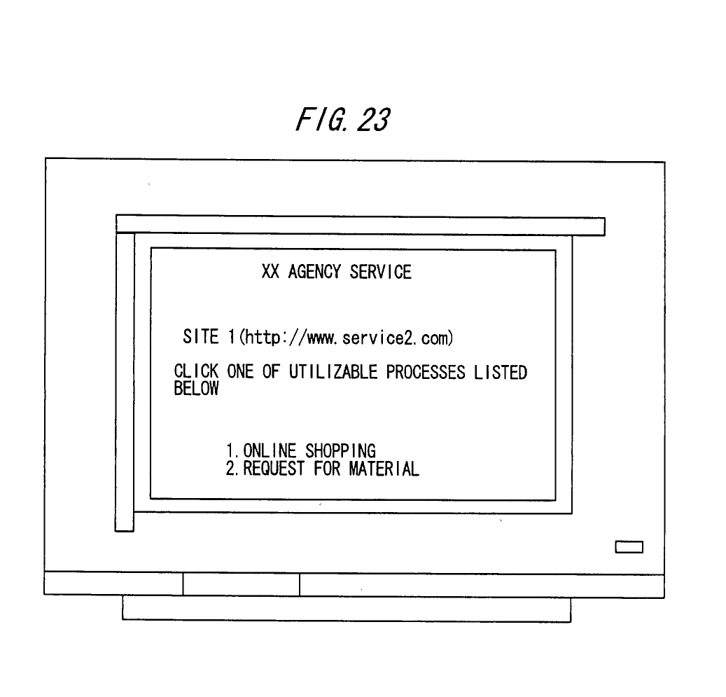

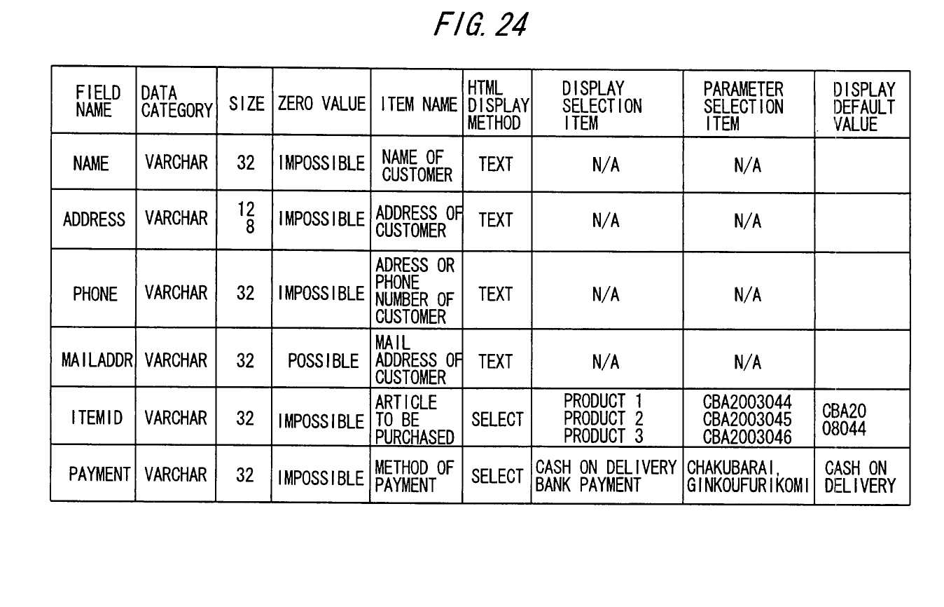

The invoked agency process request module 205 refers to the process agency schema database 210 of the service site B in order to extract a list of utilizable processes from this database 210 and transmits this list to the user terminal 400, and the list of the utilizable processes is displayed by the Browser on the user terminal 400 as shown in FIG. 23 (S3041). FIG. 24 shows an example of the schema containing the utilizable processes. The customer browses the list of utilizable processes and selects an agency process that the customer desires to utilize. The agency process request module 205 is notified of the selected agency process.

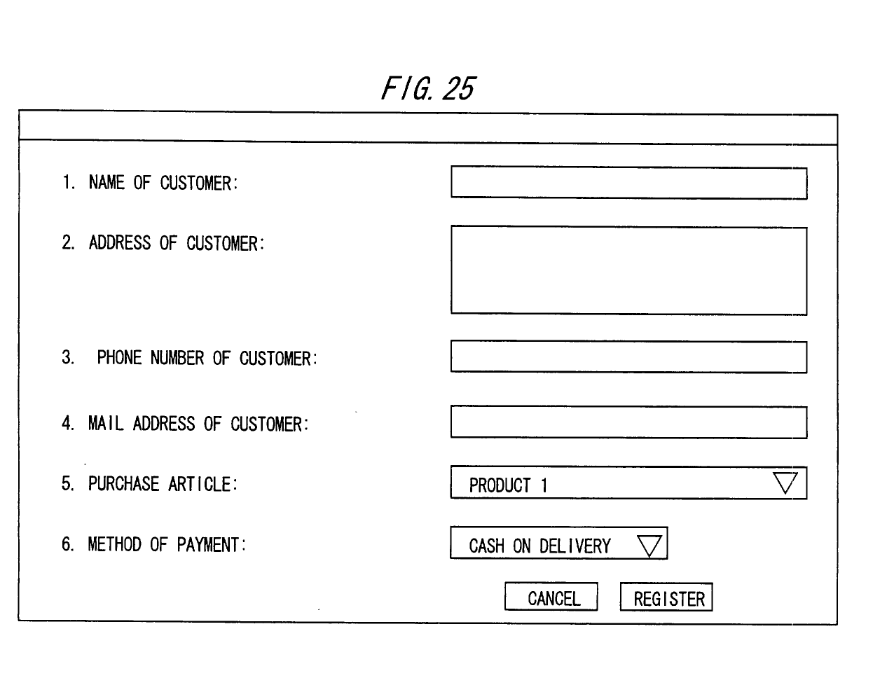

The agency process request module 205 of the agency server, when notified of the desire-to-utilize agency process, extracts from the process request schema database 210 a process request schema containing input items needed for purchasing a product etc provided on the service site B, and transmits an inform form based on this schema as shown in FIG. 25 to the customer (S3042). Note that an interchange of the information (data) entered in the input fields is conducted involving the use of the process request schema database and can also be actualized by utilizing DIA (Document Interchange Architecture) using XML (Extensible Markup Language) etc.

The customer inputs pieces of information into the input items specified, and sends the information-inputted items back to the agency process request module 205. The agency process request module 205 accepting these items sent back therefrom transmits the same items to the process accept module 505 of the Web server 500 (S3043). Further, the agency process request module 205 registers on the agency process information database 212 a piece of information indicating that the accept process as the agency process is executed in place of the service site (S3044).

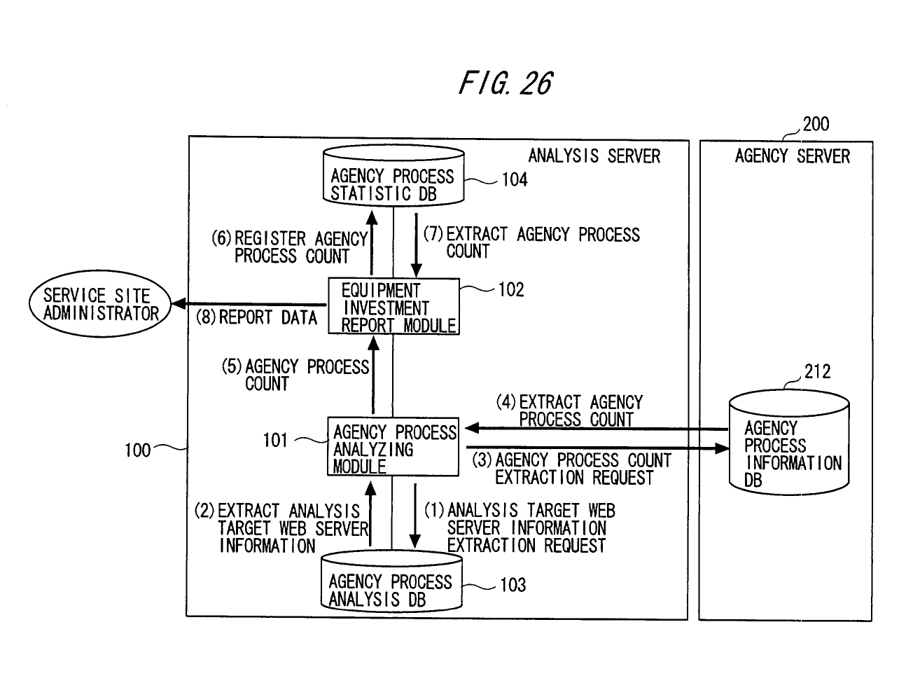

Next, an operation of the analysis server 100 included in the service request agency system will be explained with reference to the drawings. FIG. 26 is an explanatory diagram showing the operation of the analysis server included in the service request agency system.

The agency process analyzing module 101 of the analysis server 100 is periodically booted. The agency process analyzing module 101, when booted, extracts information on an analysis target Web server from the agency process analysis database 103 (1), (2). The extracted analysis target Web server information contains a Web server ID for identifying the Web server, which is required for a data-linkage with the agency process analysis database 103, a report period and so on.

The agency process analyzing module 101 searches the agency process information database 212 with this extracted Web server ID used as a key, thereby extracting from the agency process information database 212 an agency process count (an agency information provision accept count or an agency process request accept count) mapped to this Web server ID (3), (4). Then, the agency process analyzing module 101 transmits to the equipment investment report module 102 a piece of information indicating whether reporting is needed or not, the extracted Web server ID and the agency process count (5).

The equipment investment report module 102 receiving these pieces of information searches the agency process statistic database 104 with the Web server ID used as a key, and registers the agency process count (in a corresponding field) (6). Further, the equipment investment report module 102, when sending a report to the service site administrator, reports the present agency process count inclusive of the information on the agency process counts in the past to the service site administrator (8).

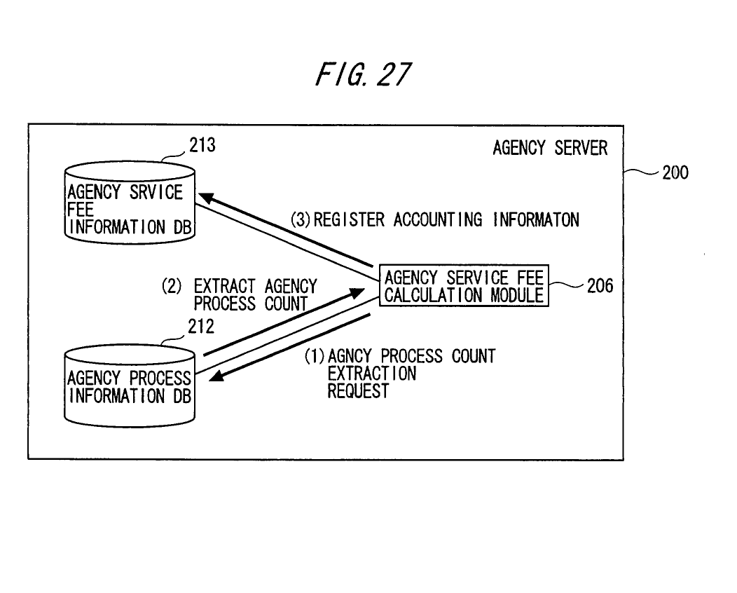

Next, an operation of the agency server included in the service request agency system will be described with reference to the drawings. FIG. 27 is an explanatory diagram showing the operation of the agency server included in the service request agency system.

The agency service fee calculating module 206 of the agency server 200 is periodically booted. The agency service fee calculating module 206, when booted, extracts an agency process request accept count from the agency process analysis database 212 (1), (2). The agency service fee calculating module 206 calculates a fee based on a category of the agency process service, and registers this fee on the agency service fee information database 213 (3).

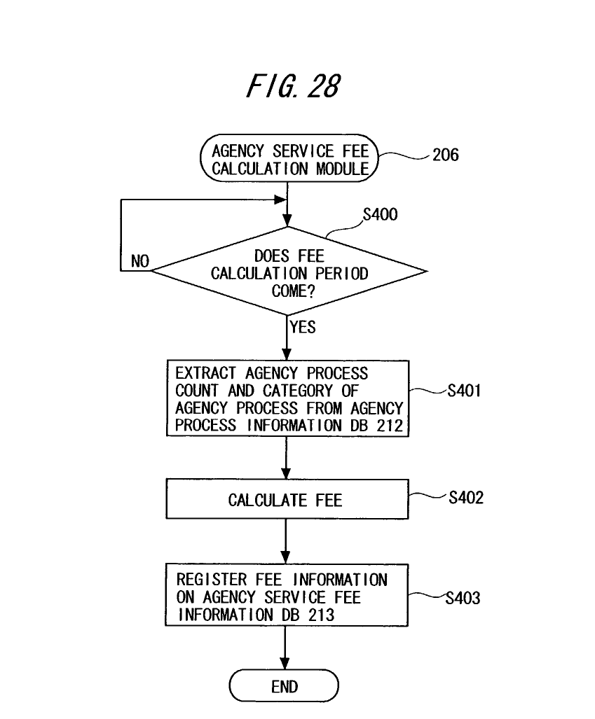

Next, an operation (the agency access accept) of the agency server included in the service request agency system will be explained in greater detail with reference to the drawings. FIG. 28 is an explanatory flowchart showing an operation of the agency service fee calculating module 206 of the agency server 200 included in the service request agency system.

The agency service fee calculating module 206 is periodically booted during a report period agreed upon with the service site administrator (S600: Yes). The agency service fee calculating module 206 refers to the agency process information database 212 and extracts an accept count of the agency information providing service and an accept count of the agency process request service therefrom (S401). The agency service fee calculating module 206 calculates a fee for utilizing the agency service from the respective accept counts (S402), and registers a result of the calculation on the agency service fee information database 212 (S403).

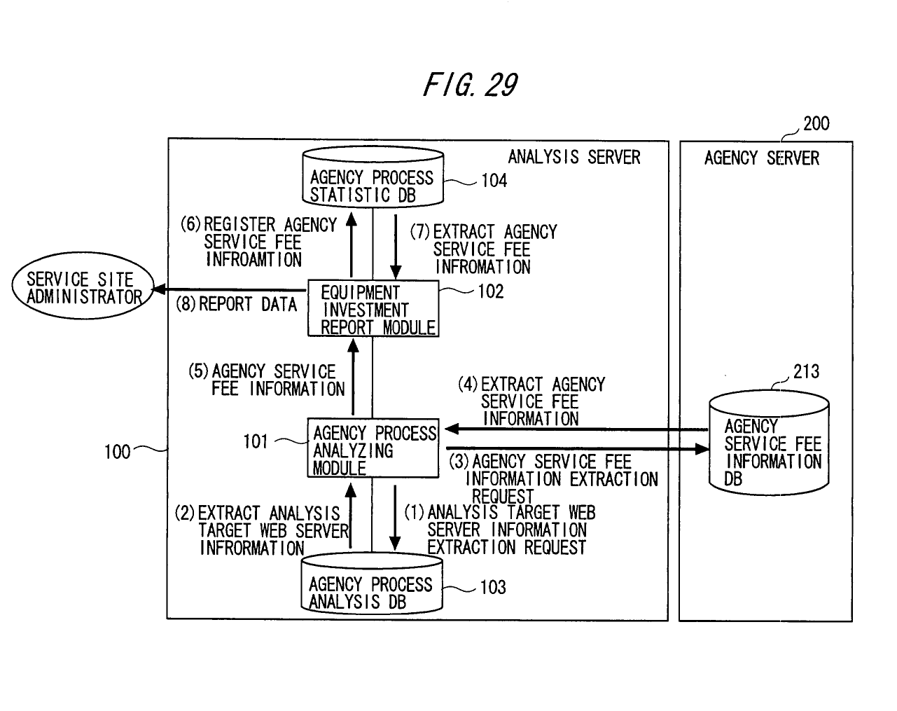

Next, an operation of the analysis server included in the service request agency system will be described with reference to the drawings. FIG. 29 is an explanatory diagram showing the operation of the analysis server included in the service request agency system.

The agency process analyzing module 101 of the analysis server 100 is periodically booted. The agency process analyzing module 101, when booted, extracts pieces of information on an analysis target Web server from the agency process analysis database 103 (1), (2). The pieces of analysis target Web server information to be extracted are a Web server ID for identifying the Web server, which is required for a data-linkage with the agency process analysis database 103, a report period, a piece of agency service fee information indexing information and so on.

If the agency service fee information indexing information indicates to the service site administrator that there is an analysis of a fluctuation in the agency service fee (information), the agency process analyzing module 101 searches the agency service fee information database 213 with the extracted Web server ID used a key, thereby extracting information on the agency service fee charged for performing the agency process in place f the Web server from this agency service fee information database 213 (3), (4).

Then, the agency process analyzing module 101 transmits to the equipment investment report module 102 a piece of information showing whether there is a necessity of reporting, the extracted Web server ID and the agency service fee information (5). Subsequently, the equipment investment report module 102 searches the agency process statistic database 104 with the Web server ID used as a key, and registers the agency service fee information (in a corresponding field) (6). Further, the equipment investment report module 102, when reporting to the service site administrator, the agency process count together with the agency service fee information in the past is reported to the service site administrator (8).

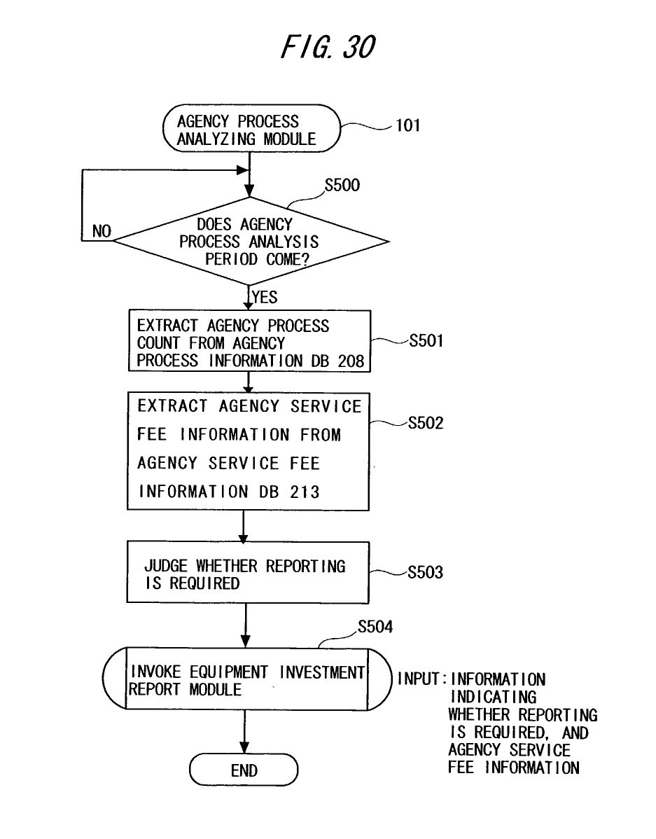

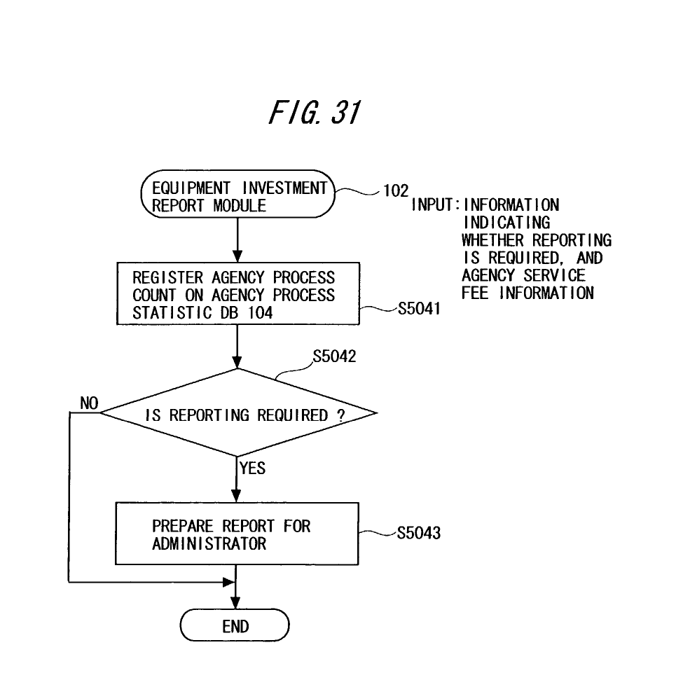

Next, an operation (agency access accept) of the analysis server included in the service request agency system will be described with reference to the drawings. FIG. 30 is an explanatory flowchart showing a process of the agency process analyzing module 101. FIG. 31 is an explanatory flowchart showing a process of the equipment investment report module 102. The agency access accept will be explained referring to these flowcharts in FIGS. 30, 31 and FIG. 18. It is herein assumed that the Web server of the service site B is defined as a customer relation management target Web server.

(1) Start of Agency Process Analysis Service

The agency service administrator sets a report period on the agency process analysis database 207 of the analysis server 100 in order to make a customer relation management function effective. The agency process analyzing module 101, to start with, extracts a report period from the agency process analysis database 103 in order to set the report period (S500). Herein, the report period is set to one week, and a boot period of the agency process analyzing module 101 is set to a one-day interval.

(2) Implementation of Agency Process Analysis Service

The agency process analyzing module 101 is booted at the one-day interval (S500: Yes), and extracts the information on an analysis target Web server 500 from the agency process analysis database 103. Pieces of analysis target Web server information to be extracted are a Web server ID for identifying the Web server, which is required for a data-linkage with the agency process information database 207, and a report period.

The agency process analyzing module 101 searches the agency process information database 212 with the extracted Web server identification ID used as a key, there by extracting an agency process count defined as the number of executing the agency process in place of the Web server 500 (S501). The agency process analyzing module 101 further searches the agency service fee database 213 with the extracted Web server identification ID used as a key, thereby extracting a piece of agency service fee information of the agency service fee for executing the agency process as a substitute for the Web server 500 (S502).

The agency process analyzing module 101 judges whether there is a necessity of reporting (S503) and, as a result of this judgement, transmits the extracted Web server identification ID, the agency process count and the agency service fee information to the equipment investment report module 102 (S504).

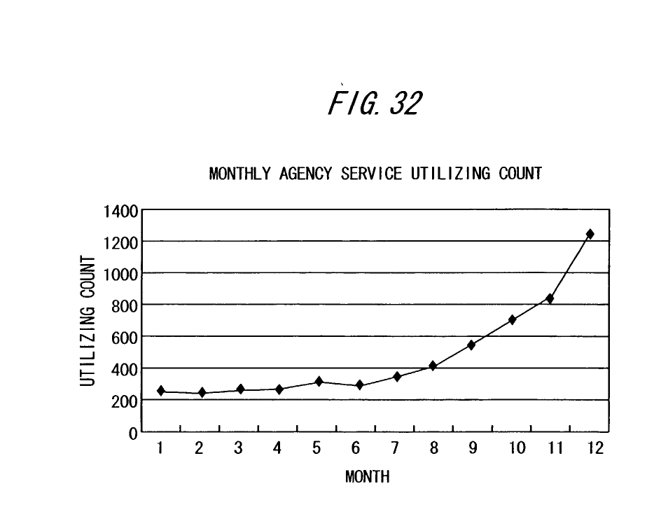

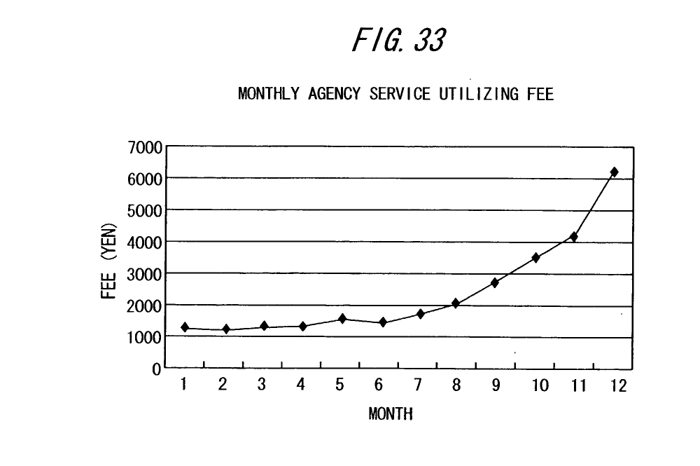

As shown in FIG. 31, the equipment investment report module 102 searches the agency process statistic database 104 with the Web server Identification ID used as a key in order to extract an agency process count and a piece of agency service fee information, and register them (S5041). Further, the equipment investment report module 102, when reporting to the service site administrator (S5042: Yes), reports to the service site administrator the agency process count and the agency service fee together with the information on the agency process count (FIG. 32) and the agency service fee (FIG. 33) in the past.

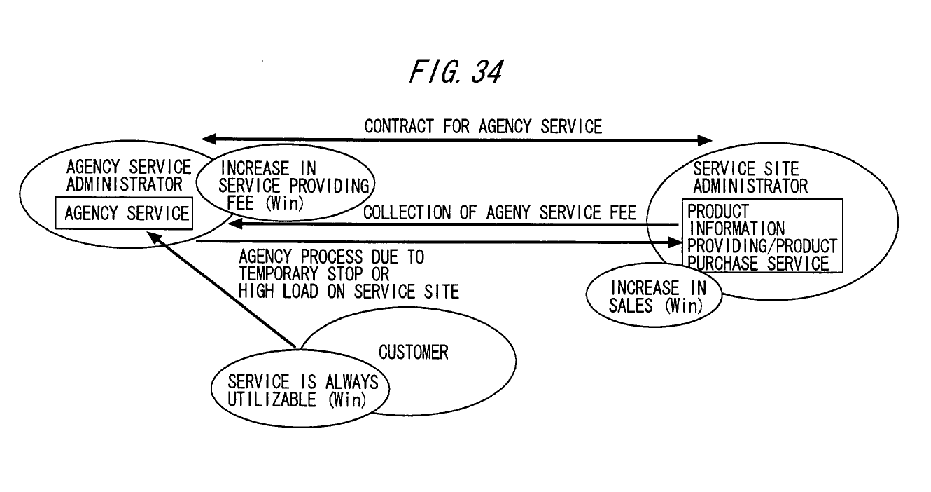

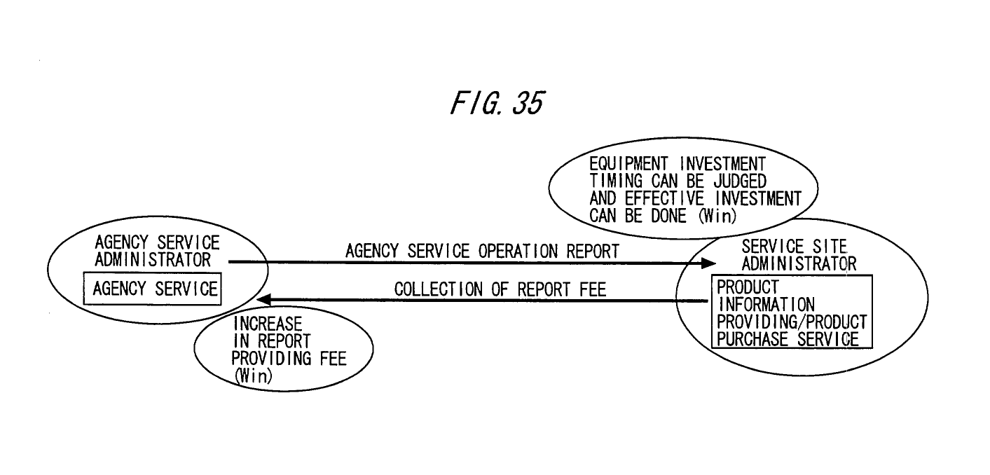

Next, FIG. 34 shows a business model in the agency service for accepting, if the Web server of the service site undergoes the high load or is temporarily stopped for the maintenance etc on the Internet, the service request from the customer as a surrogate party.

The service site administrator and the agency system administrator agree upon what agency process service should be carried out, the agency system administrator registers the Web site as a contract service site in the agency system, and provides an agency service for accepting the service of the service site as the surrogate party if the service site undergoes the high-load or is temporarily stopped due to the maintenance etc.

The service site administrator is able to, even if the service site undergoes the high-load or is temporarily stopped due to the maintenance etc, increase a sales volume by accepting the product purchase requests via the agency server as the customers' service requests. The agency system administrator collects agency service fees for the agency services conducted as the surrogate party for the contract service site by use of the agency system.

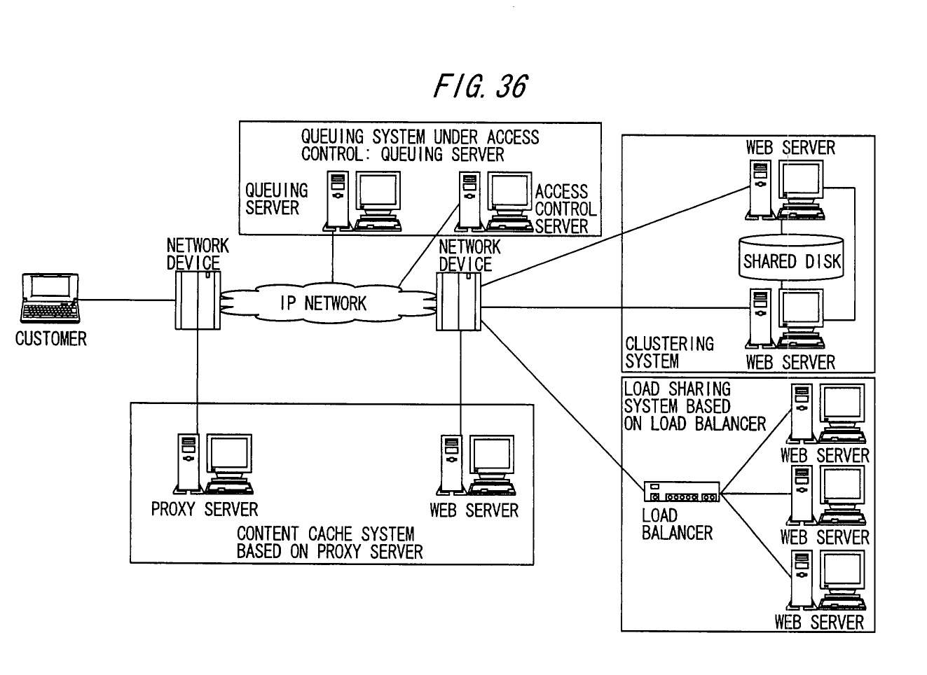

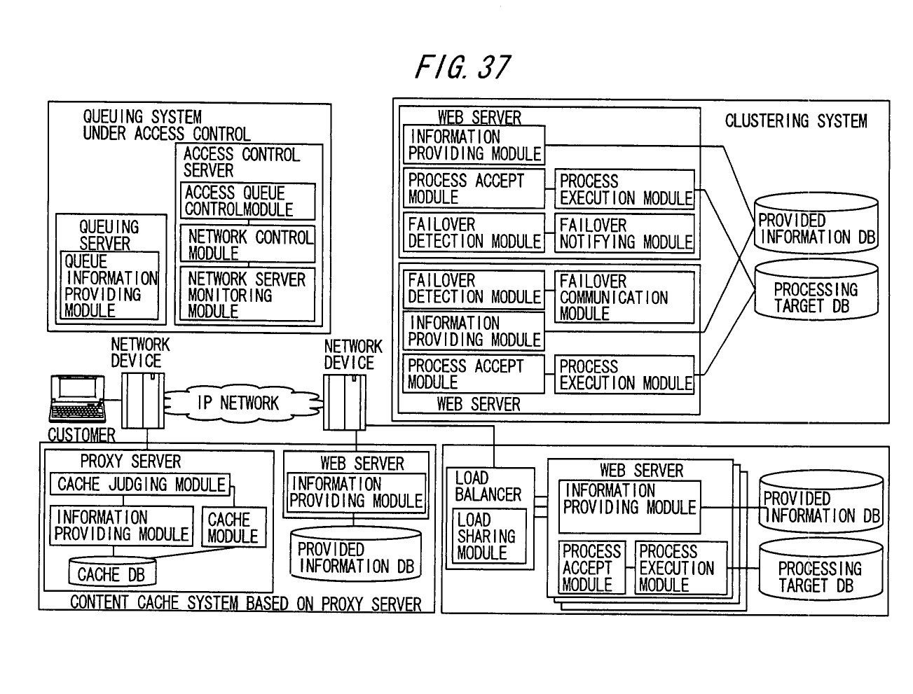

Next, FIG. 36 shows a business model in provisioning for accepting, if the Web server of the service site undergoes the high load or is temporarily stopped for the maintenance etc on the Internet, the service request from the customer as the surrogate party.

The agency system administrator reports a transition of the agency service fee for the agency service conducted as the surrogate party for the contract service site and also reports a transition of the agency service fee in the past, thereby collecting an added fee from the service site administrator. The service site administrator may judge based on contents of the reports which is profitable, an extension of the Web servers or a continuation of the agency service in terms of a future aspect.

The present invention can be embodied in a variety of forms without deviating from the sprit or the major features of the present invention. Therefore, the embodiments discussed above are mere exemplifications in every aspect and should not be construed restrictively.

As discussed above, according to the present invention, even if the server is not in the state of being able to properly provide the service due to the high-load state caused by the concentrated accesses from the customers and the stopped state, the service can be stably provided to the customers.

Further, according to the present invention, the processes that can not be executed by the equipment on the side of the service site are surrogated, whereby the service site administrator can provide the stable services to the customers by use of the existing equipment without any necessity for a futile investment in the equipment responding to a peak time. Then, the service site administrator can scheme to remarkably increase the sales volume by utilizing both the agency service and the existing equipment.

Moreover, according to the present invention, the service site administrator may judge, from the analysis of the agency process count and accounting based on the agency process, which is profitable, the investment in the equipment on the side of the service site or the continuation of the agency service. The service site administrator can perform an effective investment in the equipment in a way that reduce an extra equipment investment cost, while the agency service provider can gain the fees for the agency services and a margin of proceeds through the agency services from the service site administrator, and can thus acquire the profits.

Further, according to the present invention, with respect to the Web page requiring the input information from the customer such as the customer's purchasing the product, which remains unsolved by the proxy-server-based content cache system, the service request is accepted and implemented as the surrogate party for the customer, whereby this type of Web page can be utilized.

Furthermore, according to the present invention, in addition to the effects described above, in the case where the processes surrogated by the agency server are statistically retained and the service site carries out an extension of the servers, a degree of how much the effect was is compared with the effects before and after the investment in the equipment, and can be thus evaluated.

Moreover, according to the present invention, even if the Web server of the service site receives the high load, the customer may simply request the agency server to surrogate the service request, thereby making it possible to obviate such a problem inherent in the queuing system under the access control that the customer must wait.

What is claimed is:

1. A service request agency method of surrogating a service request to a first server for providing a service corresponding to the service request obtained via a network, said method comprising:
transferring via the network a service request from a client to said first server after judging that said first server is not in a state of being able to properly provide a service;
making a second server obtain the transferred client's service request;
retaining the obtained client's service request on a storage module;
monitoring a state of said first server; and
notifying said first server of the client's service request via the network that is retained on said storage module when monitoring a state of said first server and judging that said first server reverts to the state of being able to properly provide the service.

2. A service request agency method according to claim 1, further comprising:
transferring via the network the client's service request to said first server after judging that said first server is in the high-load state; and
notifying said first server of the client's service request retained in said storage module via the network if the high-load state of said first server is canceled.

3. A service request agency method according to claim 1, further comprising:
transferring via the network the client's service request to said first server after judging that said first server is in a stopped state; and
notifying said first server of the client's service request retained in said storage module via the network if the stopped state of said first server is canceled.

4. A service request agency method according to claim 1, wherein the client's service request contains product information needed by the customer and an address or phone number of the customer.

5. A service request agency method according to claim 1, wherein the client's service request contains information needed when purchasing the product.

6. A service request agency method according to claim 1, further comprising:
analyzing a fluctuation in a service request count of the client's service requests retained on said storage module, of which said first server was notified; and
reporting whether an extension of equipment should be done on the side of said first server on the basis of this analysis.

7. A service request agency method according to claim 1, wherein the client's service request contains a agency process category, and
an agency service fee is calculated based on the service request count of the client's service requests retaining on said storage module, of which said first server was notified, and the agency process category.

8. A service request agency method according to claim 7, further comprising:
analyzing a fluctuation in the agency service fee for said first server by referring to the service request count of the client's service requests retained on said storage module, of which said first server was notified, and the calculated agency service fee; and
reporting whether the extension of the equipment should be done on the side of said first server on the basis of this analysis.

9. A service request agency server for surrogating a service request to a first server for providing a service corresponding to the service request obtained via a network, said server comprising:
an acquisition module acquiring a service request from a client to said first server after judging that said first server is not in a state of being able to properly provide a service;
a storage module retaining the client's service request acquired by said acquisition module; and
a notifying module notifying said first server of the client's service request via a network that is retained on said storage module when judging that said first server reverts to the state of being able to properly provide the service.

10. A service request agency system for surrogating a service request to a first server for providing a service corresponding to the service request obtained via a network, said server comprising:
a monitoring module monitoring a state of said first server;
a transfer module transferring via the network a service request from a client to said first server after said monitoring module has judged that said first server is not in a state of being able to properly provide a service; and
a second server acquiring the client's service request transferred by said transfer module, retaining the acquired client's service request on a storage module, and notifying said first server of the client's service request via the network that is retained on said storage module when said monitoring module judges that that said first server reverts to the state of being able to properly provide the service.

11. A service request agency system according to claim 10, wherein said monitoring module judges, when said first server is in a high-load state, that said first server is not in a state of being able to properly provide a service and judges, when the high-load state of said first server is canceled, that said first server reverts to the state of being able to properly provide the service.

12. A service request agency system according to claim 10, wherein said monitoring module judges, when said first server is in a stopped state, that said first server is not in a state of being able to properly provide a service and judges, when the stopped state of said first server is canceled, that said first server reverts to the state of being able to properly provide the service.

13. A service request agency system comprising:
a user terminal connected to an IP network and used by a customer for referring to product information and performing an operation of purchasing a product and so on;
a Web server connected to the IP network and having a service site for providing a service to the customer;
an agency server surrogating a service request given from the customer;
an access control server having a server monitoring module monitoring a load of said Web server, and a network control module making the service request take a bypass to said agency server when said Web server falls into a high load; and
an analysis server analyzing an agency process count and an agency service fee, said agency server including:
an agency process database retaining information indicating whether said Web server undergoes the high load or is temporarily stopped;
an agency process request buffer caching the service given from the customer;
a provided information list database retaining a list of information provided on each service site;
an agency process operation input module inputting information of said Web server of the service site of which a contract has been previously established by an agency system administrator and information indicating whether said Web server is on its maintenance;
an agency access accept module surrogation-accepting the service request from the customer; and
an agency information collection accept module requesting said Web server to collect the information in place of the customer.

14. A service request agency system according to claim 13, wherein said agency server includes a process agency schema database retaining a schema of input data necessary when surrogation-accepting a service request for purchasing a product, and an agency process request module making a product purchase request etc in place of the customer to said server of the service site.

15. A service request agency system according to claim 13, wherein said agency server includes a agency process information database retaining an agency accept count for said every Web server of each service site, and
said analysis server includes an agency process analysis database retaining information of an analysis target Web server, an agency process statistic database retaining an agency process count in the past, an agency process analyzing module extracting the agency accept count from said agency process information database of said agency server, and an equipment investment report module reporting the agency accept count in the past for every agency service.

16. A service request agency system according to claim 13, wherein said agency server includes an agency service fee information database retaining an agency service fee, and an agency service fee calculating module calculating an agency service fee based on the agency service category and the agency accept count.

17. A service request agency system according to claim 15, wherein said agency server includes an agency service fee information database retaining the agency service fee for said every Web server of each service site, and
said analysis server includes an agency process analyzing module extracting the agency service fee from said agency service fee information database of said agency server, and an equipment investment report module reporting the agency service fee in the past for every agency service.

18. An agency service in an agency system surrogation-accepting a service request from a customer when a Web server of a service site undergoes a high load or is temporarily stopped for its maintenance on the Internet, said service comprising:
a procedure getting a content of what agency process service is implemented agreed upon between a service site administrator and an agency system administrator;
a procedure making said agency system administrator register a Web site of the agreed service site in said agency system, and surrogation-accepting a service of the service site if the service site undergoes a high load or is temporarily stopped for a maintenance;
a procedure bringing about an increase in sales to said service site administrator by accepting service requests from customers such as a product purchase request etc via an agency server; and
a procedure making said agency system administrator collect agency service fees for the agency services conducted in place of the agreed service site.

19. An agency service according to claim 18, further comprising:
a procedure making said agency system administrator report a transition of the agency service fee for the agency service conducted in place of the agreed service site;
a procedure making said agency system administrator collect an added fee from said service site administrator by reporting a transition of the agency service fee in the past; and
a procedure making said service site administrator judge from a content of the report which is profitable in a future aspect, an extension of said Web servers or a continuation of said agency service.
